(19) United States
(12) Patent Application Publication
(10) Pub. No.: US 2021/0364059 A1
(43) Pub. Date: Nov. 25, 2021

(54) VIBRATION ISOLATOR

(71) Applicant: DENSO CORPORATION, Kariya-city (JP)

(72) Inventors: Kazuhiro HAYASHI, Nisshin-city (JP); Yasutane HIJIKATA, Kariya-city (JP)

(73) Assignee: DENSO CORPORATION, Kariya-city (JP)

(21) Appl. No.: 17/396,476

(22) Filed: Aug. 6, 2021

Related U.S. Application Data
(63) Continuation of application No. PCT/JP2020/001329, filed on Jan. 16, 2020.

(30) Foreign Application Priority Data
Feb. 8, 2019 (JP) 2019-021775
Apr. 2, 2019 (JP) 2019-070842

(51) Int. Cl. F16F 15/08; F16F 3/087

(52) U.S. Cl. CPC F16F 15/08; B60H 1/3229; F16F 3/0876

(57) ABSTRACT

A vibration isolator configured to restrict vibration generated in a vibration source from being transmitted to a vibration transmitted portion includes at least one elastic member. The vibration transmitted portion is provided with at least one support portion to support the vibration source via the at least one elastic member. The at least one elastic member is disposed between the vibration source and at least the one support portion, and is elastically deformed to suppress the transmission of vibration of the vibration source to the vibration transmitted portion from the at least one support portion. The vibration source and at least the one elastic member are configured so that resonance frequencies in plural vibration modes generated in the vibration source conform to one predetermined frequency.

### CROSS REFERENCE TO RELATED APPLICATION

The present application is a continuation application of International Patent Application No. PCT/JP2020/001329 filed on Jan. 16, 2020, which designated the U.S. and claims the benefit of priority from Japanese Patent Application No. 2019-21775 filed on Feb. 8, 2019 and Japanese Patent Application No. 2019-70842 filed on Apr. 2, 2019. The entire disclosures of all of the above applications are incorporated herein by reference.

### TECHNICAL FIELD

The present disclosure relates to a vibration isolator.

### BACKGROUND

There is proposed a vibration isolator for a vehicle, in which an engine mount is disposed between an engine and a vehicle body to inhibit vibration generated by the rotational torque of the engine from being transmitted to the vehicle body.

### SUMMARY

According to one aspect of the present disclosure, a vibration isolator configured to restrict vibration of a vibration source from being transmitted to a vibration transmitted portion includes at least one elastic member. The vibration transmitted portion is provided with at least one support portion to support the vibration source via the at least one elastic member. The at least one elastic member is disposed between the vibration source and the at least one support portion, and is elastically deformed to suppress the transmission of vibration of the vibration source to the vibration transmitted portion from the at least one support portion. The vibration source and the at least one elastic member are configured so that resonance frequencies in a plurality of vibration modes generated in the vibration source conform to one predetermined frequency.

### BRIEF DESCRIPTION OF DRAWINGS

FIG. 1 is a front view illustrating an overall configuration of a vibration isolator according to a first embodiment for a compressor of an air-conditioner for a vehicle;

FIG. 2 is a left side view of the vibration isolator for the compressor in FIG. 1;

FIG. 3A is a diagram illustrating an elastic member according to the first embodiment and a screw member on one side and the other side of the elastic member in the axis direction;

FIG. 3B is a cross-sectional view taken along a line IIIB-IIIB of FIG. 3A;

FIG. 3C is a perspective diagram illustrating a vibration isolation member in FIG. 1 and shear rigidity k1 and k2 of the vibration isolation member;

FIG. 4 is a diagram illustrating placement of four vibration isolation members in FIG. 1, the position of the center of gravity G, elastic center Sa, and the positional relationship among points P, Q, A, B, C, and D;

FIG. 5 is a side view illustrating the vibration isolator to indicate a dimension between points A and D and a dimension between points B and C in FIG. 4;

FIG. 6 is a side view illustrating the vibration isolator to indicate a dimension between points A and B and a dimension between points C and D in FIG. 4;

FIG. 7 is a diagram illustrating installation angles between axis Xa of the vibration isolation member and ZYa and XYa according to the first embodiment;

FIG. 8 is a diagram illustrating installation angles between axis Xa of the vibration isolation member and ZYa and ZXa according to the first embodiment;

FIG. 9 is a diagram illustrating installation angles between axis Xb of the vibration isolation member and ZYb and XYb according to the first embodiment;

FIG. 10 is a diagram illustrating installation angles between axis Xb of the vibration isolation member and ZYb and ZXb according to the first embodiment;

FIG. 11 is a diagram illustrating installation angles between axis Xd of the vibration isolation member and XYd and ZYd according to the first embodiment;

FIG. 12 is a diagram illustrating installation angles between axis Xd of the vibration isolation member and ZXd and ZYd according to the first embodiment;

FIG. 13 is a diagram illustrating installation angles between axis Xc of the vibration isolation member and XYc and ZYc according to the first embodiment;

FIG. 14 is a diagram illustrating installation angles between axis Xc of the vibration isolation member and ZXc and ZYc according to the first embodiment;

FIG. 15 is a schematic diagram to supplement the explanation of the elastic center of the compressor in FIG. 1;

FIG. 16 is a schematic diagram to supplement the explanation of the elastic center of the compressor in FIG. 1;

FIG. 17 is a schematic diagram to supplement the explanation of the elastic center of the compressor in FIG. 1;

FIG. 18 is a schematic diagram to supplement the explanation of placement of the elastic center and the position of the center of gravity of the compressor in FIG. 1;

FIG. 19 is a schematic diagram to supplement the explanation of vibration directions Y, Z, φ, and Ψ in the compressor in FIG. 1;

FIG. 20 is a schematic diagram to supplement the explanation of vibration directions X and θ in the compressor in FIG. 1;

FIG. 21 is a diagram illustrating the comparison between the vibration transmissibility of the vibration isolator in FIG. 1 and the vibration transmissibility of a conventional vibration isolator;

FIG. 22 is a left side view of a vibration isolator for a compressor of an air-conditioner for a vehicle according to a second embodiment;

FIG. 23 is a front view of the vibration isolator for the compressor in FIG. 22;

FIG. 24 is a perspective diagram illustrating a vibration isolation member in FIG. 22 and shear rigidity k1 and k2 of the vibration isolation member;

FIG. 25 is a diagram illustrating placement of four vibration isolation members in FIG. 22, the position of the center of gravity G, elastic center Sa, and the positional relationship among points P, Q, A, B, C, and D;

FIG. 26 a front view illustrating an overall configuration of a vibration isolator for a compressor of an air-conditioner for a vehicle according to a third embodiment;

FIG. 27 is a left side view of the vibration isolator for the compressor in FIG. 26;

FIG. 28 is a left side view as a schematic diagram illustrating the position of the center of gravity G set to be high in the vibration isolator of the compressor according to a comparative example of the third embodiment;

FIG. 29 is a front view as a schematic diagram illustrating the position of the center of gravity G set to be high in the vibration isolator of the compressor according to a comparative example of the third embodiment;

FIG. 30 is a left side view as a schematic diagram illustrating the position of the center of gravity G set to be low in the vibration isolator of the compressor according to a comparative example of the third embodiment;

FIG. 31 is a front view as a schematic diagram illustrating the position of the center of gravity G set to be low in the vibration isolator of the compressor according to a comparative example of the third embodiment;

FIG. 32 is a front view as a schematic diagram illustrating a vibration isolator for a compressor of an air-conditioner for a vehicle according to a fourth embodiment;

FIG. 33 is a left side view as a schematic diagram illustrating the vibration isolator of the compressor according to the fourth embodiment;

FIG. 34 is a front view of an upper support portion as a unit according to a fifth embodiment viewed from the top;

FIG. 35 is a bottom side view of the upper support portion as a unit in FIG. 34;

FIG. 36 is a left side view of the upper support portion as a unit in FIG. 34;

FIG. 37 is a front view of an elastic member according to a sixth embodiment viewed from a direction orthogonal to the axis;

FIG. 38 is a cross-sectional view taken along a line XXXVIII-XXVIII of FIG. 37;

FIG. 39 is a diagram illustrating the placement of four elastic members in XYZ axis coordinates to explain fx, fy, fz, fφ, fΨ, and fθ when k1≠k2≠k3 is satisfied according to the fifth embodiment;

FIG. 40 is a diagram illustrating four elastic members in FIG. 39 viewed in the X-axis direction;

FIG. 41 is a diagram illustrating four elastic members in FIG. 39 viewed in the Y-axis direction;

FIG. 42 is a front view of the elastic member according to a first modification of the sixth embodiment viewed from a direction orthogonal to the axis;

FIG. 43 is a cross-sectional view taken along a line XLIII-XLIII of FIG. 42;

FIG. 44 is a front view of the elastic member according to a second modification of the sixth embodiment viewed from a direction orthogonal to the axis;

FIG. 45 is a cross-sectional view taken along a line XLV-XLV of FIG. 44;

FIG. 46 is a front view of the elastic member according to a third modification of the sixth embodiment viewed from a direction orthogonal to the axis;

FIG. 47 is a cross-sectional view taken along a line XLVII-XLVII of FIG. 46;

FIG. 48 is a front view of the elastic member according to a fourth modification of the sixth embodiment viewed from a direction orthogonal to the axis;

FIG. 49 is a cross-sectional view taken along a line XLIX-XLIX of FIG. 48;

FIG. 50 is a front view of the elastic member according to a fifth modification of the sixth embodiment viewed from a direction orthogonal to the axis;

FIG. 51 is a cross-sectional view taken along a line LI-LI of FIG. 50;

FIG. 52 is a cross-sectional view taken along a line LII-LII of FIG. 50;

FIG. 53 is a front view of the elastic member according to a sixth modification of the sixth embodiment viewed from a direction orthogonal to the axis;

FIG. 54 is a cross-sectional view taken along a line LIV-LIV of FIG. 53;

FIG. 55 is a cross-sectional view taken along a line LV-LV of FIG. 50;

FIG. 56 is a diagram to supplement the explanation of a frequency range to which resonance frequencies in six vibration modes are converged, according to a seventh embodiment, where the vertical axis represents the vibration transmissibility of vibration transmitted from the compressor to the vehicle body and the horizontal axis represents the frequency;

FIG. 57 is a diagram illustrating differences between the maximum and minimum resonance frequencies in six vibration modes and differences between maximum and minimum resonance frequencies in six vibration modes when k1≠k2=k3 according to an eighth embodiment; and

FIG. 58 is a diagram illustrating the relationship between the magnitude of vibration of a compressor and the frequency according to a comparative example.

### DESCRIPTION OF EMBODIMENT

To begin with, examples of relevant techniques will be described.

Conventionally, there is proposed a vibration isolator for a vehicle, in which an engine mount is disposed between an engine and a vehicle body to inhibit vibration generated by the rotational torque of the engine from being transmitted to the vehicle body. Specifically, the solution is targeted at the vibration in the vehicle width direction (namely, the horizontal direction) and the vibration in the vertical direction generated by the rotational torque of the engine. The rigidity of the engine mount is reduced in the vehicle width direction and the vertical direction to restrict the vibration.

A measure is taken to suppress the coupling of vibrations in the vehicle width direction and vibrations in the vertical direction. In directions other than the vehicle width direction and the vertical direction, the rigidity of the engine mount is increased to suppress vibrations of the engine while the vehicle travels, thus ensuring travel safety.

The inventors investigated the relationship between the durability of an elastic member and the resonance frequency of an engine (namely, a vibration source) when the engine mount is provided as the elastic member such as rubber material.

Improvement in the vibration isolation for the vibration source may require decrease in the resonance frequency of the vibration source.

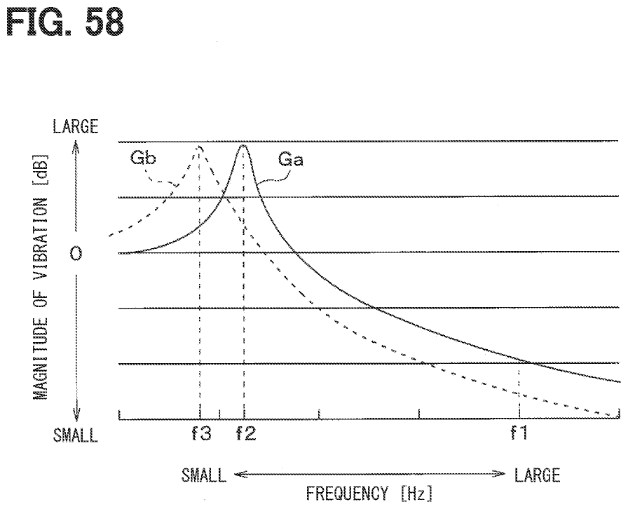

For example, suppose the vibration source has the vibration characteristics illustrated as graph Ga in FIG. 58. Then, suppose it is necessary to reduce the magnitude of the vibration at frequency f1 higher than resonance frequency f2 of the vibration source.

The resonance frequency of the vibration source may need to be decreased to frequency f3 lower than the frequency f2, as indicated by graph Gb representing the vibration characteristics of the vibration source.

Graph Gb shows the vibration characteristics when the resonance frequency is decreased to resonance frequency fb to reduce the magnitude of vibration at frequency f1.

However, if the resonance frequency of the vibration source is decreased excessively, the rigidity of the elastic member also decreases significantly. In this case, when the vibration source vibrates at the resonance frequency, the vibration of the vibration source causes large displacement in the elastic member, such that the durability of the elastic member may decrease. There is a discordance between the vibration isolation property of the vibration source and the durability of the elastic member.

In consideration of the foregoing, the present disclosure provides a vibration isolator that ensures the vibration isolation property of a vibration source while suppressing a decrease in the rigidity of an elastic member.

According to one aspect of the present disclosure, a vibration isolator configured to restrict vibration of a vibration source from being transmitted to a vibration transmitted portion includes at least one elastic member.

The vibration transmitted portion is provided with at least one support portion to support the vibration source via the at least one elastic member, the at least one elastic member is disposed between the vibration source and the at least one support portion, and is elastically deformed to suppress the transmission of vibration of the vibration source to the vibration transmitted portion from the at least one support portion, and

the vibration source and the at least one elastic member are configured so that resonance frequencies in a plurality of vibration modes generated in the vibration source conform to one predetermined frequency.

It is possible to reduce vibration transmitted from the vibration source, compared to a case where the vibration source causes different resonance frequencies in multiple vibration modes, in a frequency range higher than one predetermined frequency. Therefore, it is possible to provide a vibration isolator that ensures the vibration isolation property of the vibration source while inhibiting a decrease in rigidity of the elastic member.

Suppose the one predetermined frequency represents frequencies to achieve both the vibration isolation property of the vibration source and the durability of the elastic member. Then, it is possible to provide a vibration isolator suitable for achieving both the vibration isolation property of the vibration source and the durability of the elastic member.

It should be noted that “conformity” not only signifies strict conformity among resonance frequencies in multiple vibration modes but also an aggregation of resonance frequencies in multiple vibration modes within a predetermined range due to, for example, manufacturing errors.

According to another aspect of the present disclosure, a vibration isolator configured to restrict vibration of a vibration source from being transmitted to a vibration transmitted portion includes at least one elastic member.

The vibration transmitted portion is provided with at least one support portion to support the vibration source via the at least one elastic member,

the at least one elastic member is disposed between the vibration source and the at least one support portion, and is elastically deformed to suppress transmission of vibration of the vibration source to the vibration transmitted portion from the at least one support portion, and

when the vibration source vibrates based on six-degree-of-freedom while maintaining a correspondence between a position of center of gravity of the vibration source and an elastic center of the vibration source, the vibration source and the at least one elastic member are configured to keep an absolute value smaller than or equal to 10 Hz, the absolute value being a difference between the maximum and minimum resonance frequencies in six vibration modes corresponding to the six-degree-of-freedom.

It is possible to provide a vibration isolator that ensures the vibration isolation property of the vibration source while inhibiting a decrease in rigidity of the elastic member.

According to another aspect of the present disclosure, a vibration isolator configured to restrict vibration of a vibration source from being transmitted to a vibration transmitted portion includes: at least one first support portion to support the vibration source; and at least one elastic member.

The vibration transmitted portion is provided with at least one second support portion to support the first support portion via the at least one elastic member,

the at least one elastic member is disposed between the vibration source and the at least one second support portion, and is elastically deformed to suppress vibration of the vibration source transmitted to the first support portion from being further transmitted to the vibration transmitted portion through the at least one second support portion, and

the first support portion, the vibration source, and the at least one elastic member are configured so that resonance frequencies in a plurality of vibration modes generated in the vibration source conform to one predetermined frequency.

It is possible to reduce vibration transmitted from the vibration source, compared to a case where the vibration source causes different resonance frequencies in multiple vibration modes in a frequency range higher than one predetermined frequency. Therefore, it is possible to provide a vibration isolator that ensures the vibration isolation property of the vibration source while inhibiting a decrease in rigidity of the elastic member.

Suppose the one predetermined frequency represents frequencies to achieve both the vibration isolation property of the vibration source and the durability of the elastic member. Then, it is possible to provide a vibration isolator suitable for achieving both the vibration isolation property of the vibration source and the durability of the elastic member.

According to another aspect of the present disclosure, a vibration isolator configured to restrict vibration of a vibration source from being transmitted to a vibration transmitted portion includes: at least one first support portion to support the vibration source; and at least one elastic member.

The vibration transmitted portion is provided with at least one second support portion to support the first support portion via the at least one elastic member,

the at least one elastic member is disposed between the vibration source and the at least one second support portion, and is elastically deformed to suppress vibration of the vibration source transmitted to the first support portion from being further transmitted to the vibration transmitted portion through the at least one second support portion, and

when the vibration source vibrates based on six-degree-of-freedom while maintaining a correspondence between a position of center of gravity of the vibration source and an elastic center of the vibration source, the first support portion, the vibration source, and the at least one elastic member are configured to keep an absolute value smaller than or equal to 10 Hz, the absolute value being a difference between the maximum and minimum resonance frequencies in six vibration modes corresponding to the six-degree-of-freedom.

This makes it possible to provide a vibration isolator that ensures the vibration isolation of the vibration source while suppressing a decrease in rigidity of the elastic member.

The reference numerals in parentheses attached to the components and the like indicate an example of correspondence between the components and the like and specific components and the like described in embodiments to be described below.

Hereinafter, embodiments of the present disclosure will be described with reference to the drawings. In the following embodiments, the same or equivalent parts are denoted by the same reference numerals as each other, for simplifying the explanation.

### First Embodiment

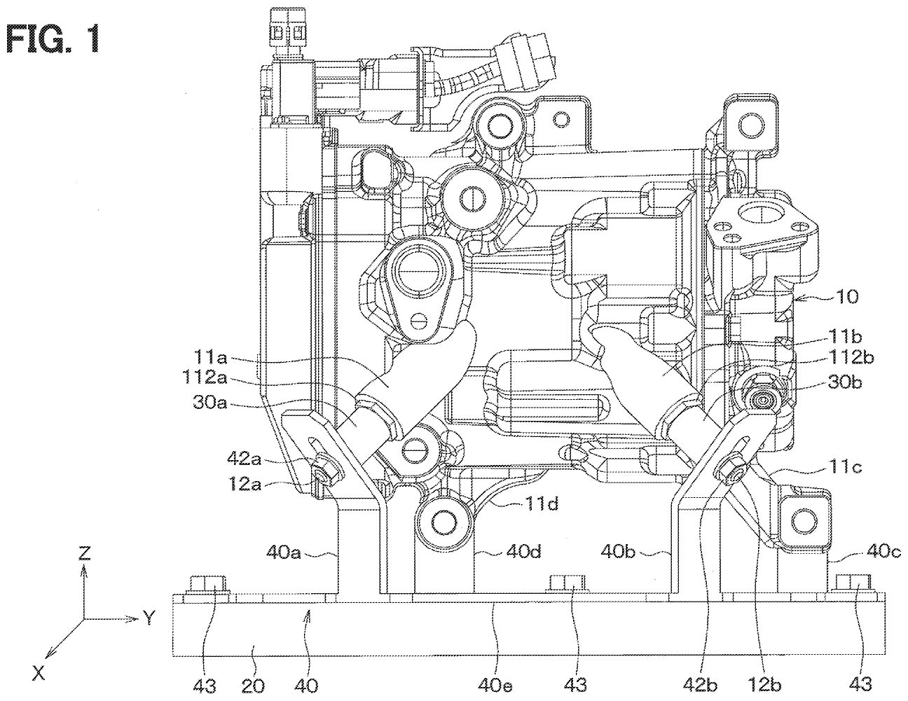

FIGS. 1, 2, 3A, 3B, 3C, and 4 illustrate the first embodiment of the vibration isolator for a compressor of an air-conditioner for a vehicle. The vibration isolator according to the present embodiment performs vibration isolation that inhibits vibration generated from the compressor 10 from being transmitted to a vehicle body 20.

The compressor 10 of an air-conditioner for a vehicle is hereinafter simply referred to as the compressor 10 for simplicity. The compressor 10 according to the present embodiment is represented as an electric compressor that uses a built-in electric motor to drive a compression mechanism.

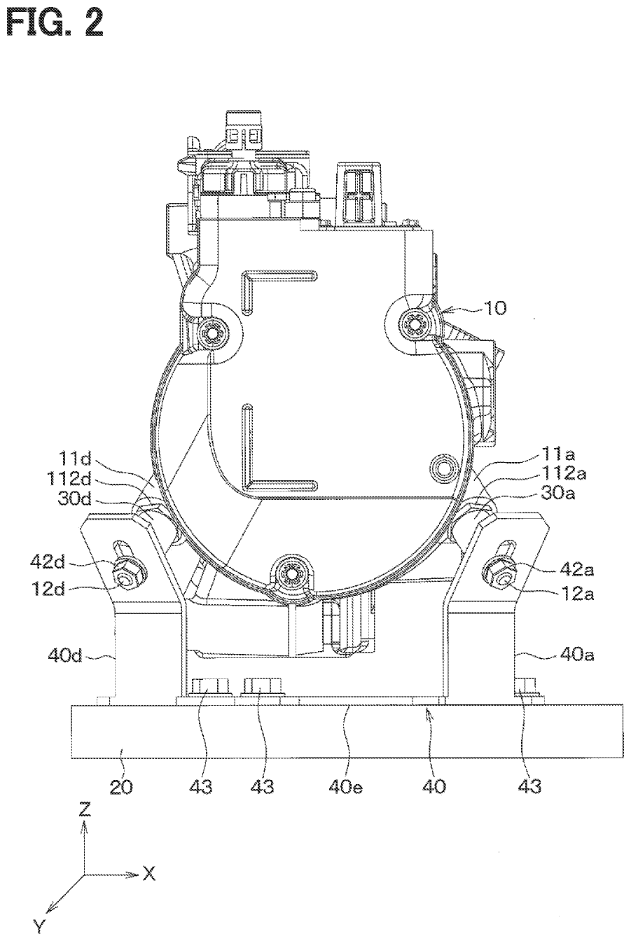

As illustrated in FIGS. 1 and 2, the vibration isolator according to the present embodiment includes one compressor 10 and four elastic members 30a, 30b, 30c, and 30d. In the following description, the four elastic members 30a, 30b, 30c, and 30d are simply referred to as elastic members 30a, 30b, 30c, and 30d.

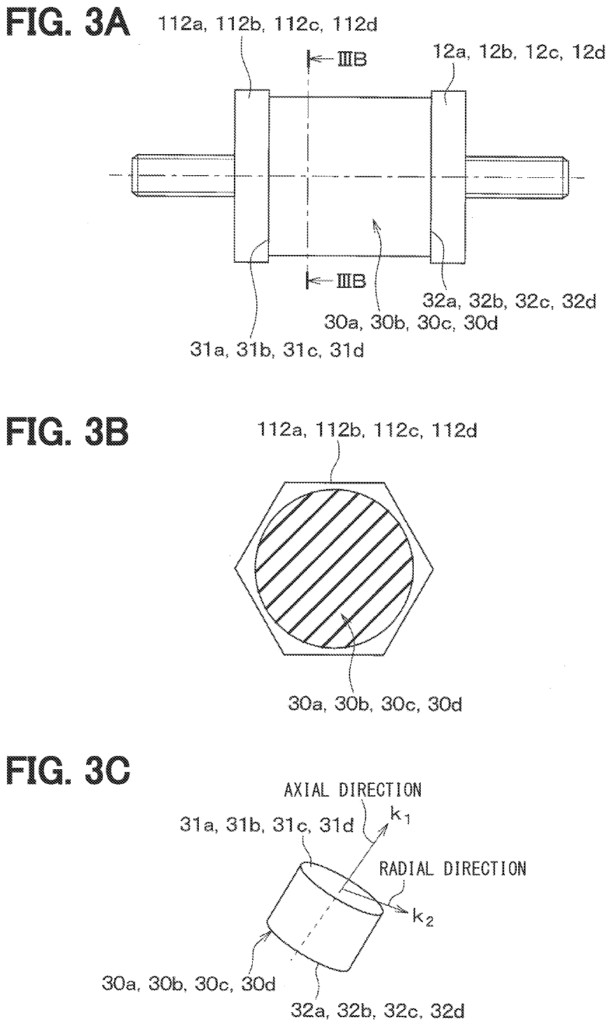

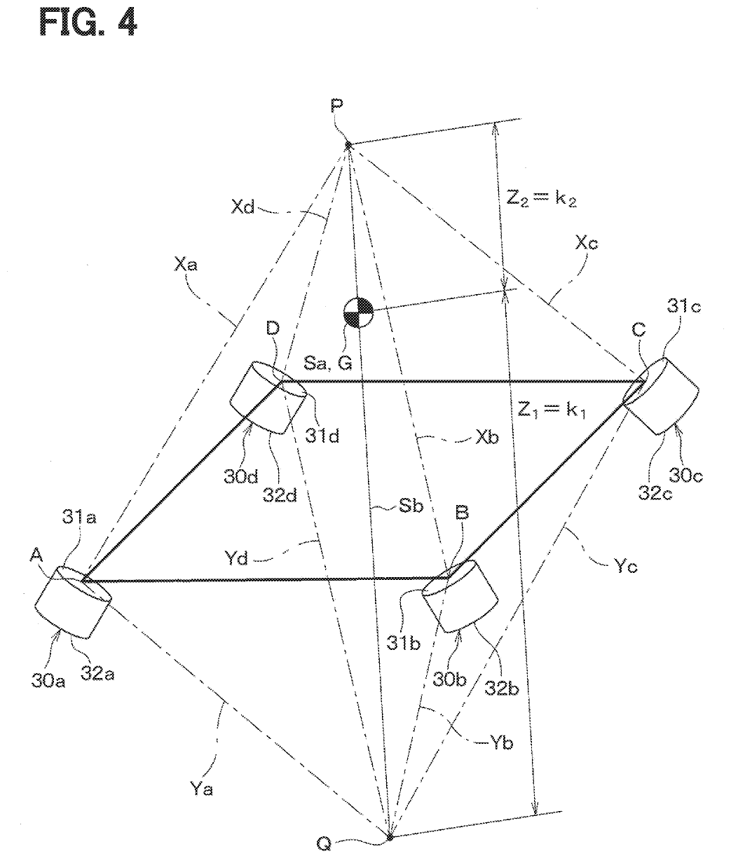

As illustrated in FIGS. 3A, 3B, 3C, and 4, each of the elastic members 30a, 30b, 30c, and 30dis formed in a columnar shape. The elastic members 30a, 30b, 30c, and 30d according to the present embodiment are formed of elastic members such as rubber.

The compressor 10 is supported by one support portion 40 via the elastic members 30a, 30b, 30c, and 30d. The support portion 40 supports the compressor 10 via the elastic members 30a, 30b, 30c, and 30d.

The support portion 40 includes four leg portions 40a, 40b, 40c, and 40d, and one plate-shaped fixing portion 40e. The four leg portions 40a, 40b, 40c, and 40d, and the fixing portion 40e are configured as an integral member.

Each of the four leg portions 40a, 40b, 40c, and 40d may be configured as a separate unit. In this case, the four leg portions 40a, 40b, 40c, and 40d are comparable to multiple support portions.

An end face 31a is provided at one side of the elastic member 30a in the axis direction. A screw member 112a adheres to the end face 31a of the elastic member 30a.

The screw member 112a is fastened to the female screw hole of a leg portion 11a of the compressor 10. The elastic member 30a thereby allows the end face 31a to support the leg portion 11a of the compressor 10.

An end face 32a is provided at the other side of the elastic member 30a in the axis direction. A screw member 12a adheres to the end face 32a of the elastic member 30a. The screw member 12a is inserted into the through-hole of the leg portion 40a of the support portion 40 and is fastened to a nut 42a.

The elastic member 30a is thus positioned between the leg portion 11a of the compressor 10 and the leg portion 40a of the support portion 40.

An end face 31b is provided at one side of the elastic member 30b in the axis direction. A screw member 112b adheres to the end face 31b of the elastic member 30b.

The screw member 112b is fastened to the female screw hole of the leg portion 11b of the compressor 10. The elastic member 30b thus allows the end face 31b to support the leg portion 11b of the compressor 10.

An end face 32b is provided at the other side of the elastic member 30b in the axis direction. A screw member 12b adheres to the end face 32b of the elastic member 30b. The screw member 12b is inserted into the through-hole of the leg portion 40b of the support portion 40 and is fastened to a nut 42b.

The elastic member 30b is thus positioned between the leg portion 11b of the compressor 10 and the leg portion 40b of the support portion 40.

An end face 31c is provided at one side of the elastic member 30c in the axis direction. A screw member 112c adheres to the end face 31c of the elastic member 30c.

The screw member 112c is fastened to the female screw hole of the leg portion 11c of the compressor 10. The elastic member 30c thus allows the end face 31c to support the leg portion 11c of the compressor 10.

An end face 32c is provided at the other side of the elastic member 30c in the axis direction. A screw member 12c adheres to the end face 32c of the elastic member 30c. The screw member 12c is inserted into the through-hole of the leg portion 40c of the support portion 40 and is fastened to an unshown nut.

The elastic member 30c is thus positioned between the leg portion 11c of the compressor 10 and the leg portion 40c of the support portion 40.

An end face 31d is provided at one side of the elastic member 30d in the axis direction. A screw member 112d adheres to the end face 31d of the elastic member 30d.

The screw member 112d is fastened to the female screw hole of the leg portion 11d of the compressor 10. The elastic member 30d thus allows the end face 31d to support the leg portion 11d of the compressor 10.

An end face 32d is provided at the other side of the elastic member 30d in the axis direction. A screw member 12d adheres to the end face 32d of the elastic member 30d. The screw member 12d is inserted into the through-hole of the leg portion 40d of the support portion 40 and is fastened to a nut 42d.

The elastic member 30d is thus positioned between the leg portion 11d of the compressor 10 and the leg portion 40d of the support portion 40.

The support portion 40 according to the present embodiment allows a fastening member 43 such as a bolt to fix the fixing portion 40e to the vehicle body 20. The support portion 40 is thus fixed to the vehicle body 20. The position of the center of gravity of the compressor 10 according to the present embodiment is hereinafter referred to as the position of the center of gravity G for explanatory convenience.

The description below explains the positional relationship between the position of the center of gravity G and each of the elastic members 30a, 30b, 30c, and 30d in an example of placing the position of the center of gravity G, the elastic members 30a, 30b, 30c, and 30d of the compressor 10 in XYZ coordinates according to the present embodiment.

As illustrated in FIG. 4, the axis of the elastic member 30a is assumed to be Xa (namely, the first line). A point overlapping with Xa on the end face 31a of the elastic member 30a is assumed to be reference point A. Reference point A is an intersection between Xa and the end face 31a.

The axis of the elastic member 30b is assumed to be Xb (namely, the first line). A point overlapping with Xb on the end face 31b of the elastic member 30b is assumed to be reference point B. Reference point B is an intersection between Xb and the end face 31b.

The axis of the elastic member 30c is assumed to be Xc (namely, the first line). A point overlapping with Xc on the end face 31c of the elastic member 30c is assumed to be reference point C. Reference point C is an intersection between Xc and the end face 31c.

The axis of the elastic member 30d is assumed to be Xd (namely, the first line). A point overlapping with Xd on the end face 31d of the elastic member 30d is assumed to be reference point D. Reference point D is an intersection between Xd and the end face 31d.

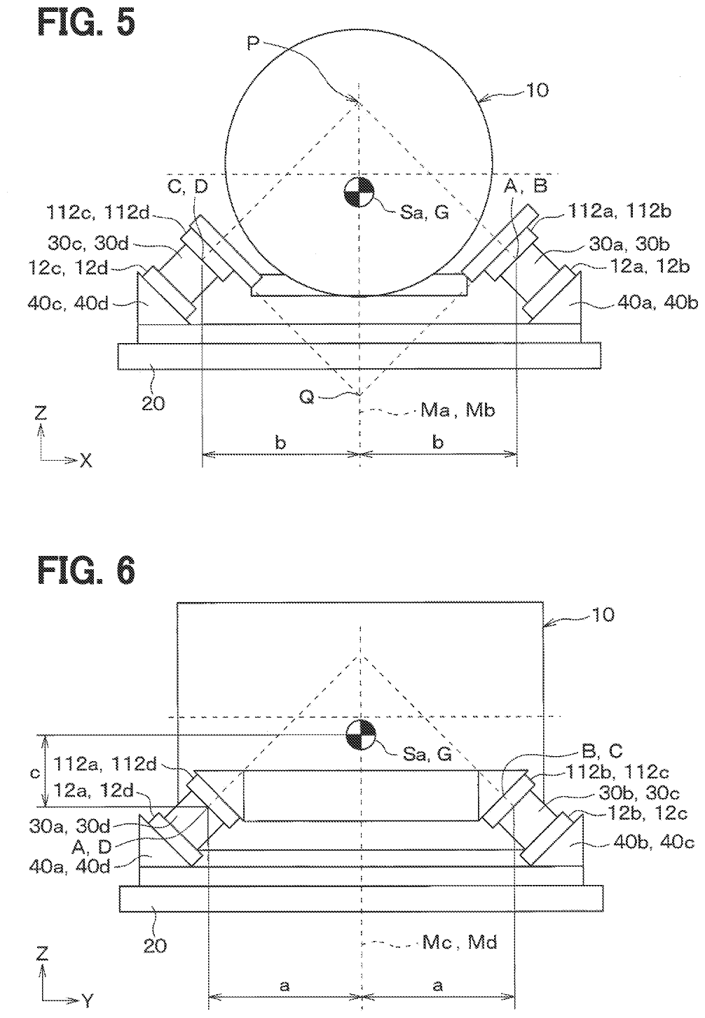

As illustrated in FIG. 5, the elastic members 30a and 30d are viewed from the positive side in the Y-axis direction. The elastic members 30a and 30d are axisymmetric along virtual line Ma as the centerline that is parallel to the Z-axis between the elastic members 30a and 30d and overlaps with the position of the center of gravity G.

Therefore, dimension b between the elastic member 30a and virtual line Ma is equal to dimension b between the elastic member 30d and virtual line Ma.

As illustrated in FIG. 5, the elastic members 30b and 30c are viewed from the negative side in the Y-axis direction. The elastic members 30b and 30c are axisymmetric along virtual line Mb as the centerline that is parallel to the Z-axis between the elastic members 30b and 30c and overlaps with the position of the center of gravity G.

Therefore, dimension b between the elastic member 30b and virtual line Mb is equal to dimension b between the elastic member 30c and virtual line Mb.

As illustrated in FIG. 6, the elastic members 30a and 30b are viewed from the positive side in the X-axis direction. The elastic members 30a and 30b are axisymmetric along virtual line Mc as the centerline that is parallel to the Z-axis between the elastic members 30a and 30b and overlaps with the position of the center of gravity G.

Therefore, dimension a between the elastic member 30a and virtual line Mc is equal to dimension a between the elastic member 30b and virtual line Mc.

As illustrated in FIG. 6, the elastic members 30c and 30d are viewed from the negative side in the X-axis direction. The elastic members 30c and 30d are axisymmetric along virtual line Md as the centerline that is parallel to the Z-axis between the elastic members 30c and 30d and overlaps with the position of the center of gravity G.

Therefore, dimension a between the elastic member 30c and virtual line Md is equal to dimension a between the elastic member 30d and virtual line Md.

According to the present embodiment, reference points A, B, C, and D of the elastic members 30a, 30b, 30c, and 30d are positioned on one plane parallel to the X-axis and the Y-axis.

As illustrated in FIG. 6, dimension c defines the shortest distance between the plane to place reference points A, B, C, and D and the position of the center of gravity G. The defined dimensions a, b, and c are hereinafter referred to as mounting positions (a, b, c) of the elastic members 30a, 30b, 30c, and 30d.

The plane that includes reference point A and is parallel to the X-axis and the Y-axis is hereinafter referred to as XYa. The plane that includes reference point A and is parallel to the Z-axis and the Y-axis is hereinafter referred to as ZYa.

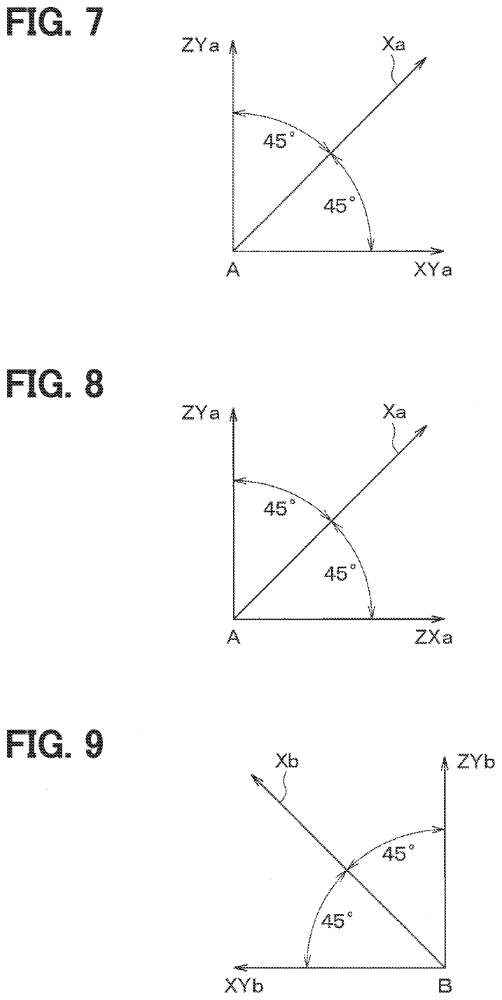

As illustrated in FIG. 7, a 45-degree angle is formed clockwise from Xa to XYa between Xa and XYa. A 45-degree angle is formed clockwise from ZYa to Xa between ZYa and Xa.

The plane that includes reference point A and is parallel to the Y-axis and the Z-axis is hereinafter referred to as ZYa. The plane that includes reference point A and is parallel to the X-axis and the Z-axis is hereinafter referred to as ZXa.

As illustrated in FIG. 8, a 45-degree angle is formed clockwise from ZYa to Xa between Xa and ZYa. A 45-degree angle is formed clockwise from Xa to ZXa between Xa and ZXa.

The plane that includes reference point B and is parallel to the X-axis and the Y-axis is hereinafter referred to as XYb. The plane that includes reference point B and is parallel to the Z-axis and the Y-axis is hereinafter referred to as ZYb.

As illustrated in FIG. 9, a 45-degree angle is formed counterclockwise from Xb to the XYb parallel plane between Xb and XYb. A 45-degree angle is formed counterclockwise from ZYb to Xb between ZYb and Xb.

The plane that includes reference point B and is parallel to the Y-axis and the Z-axis is hereinafter referred to as ZYb. The plane that includes reference point B and is parallel to the X-axis and the Z-axis is hereinafter referred to as ZXb.

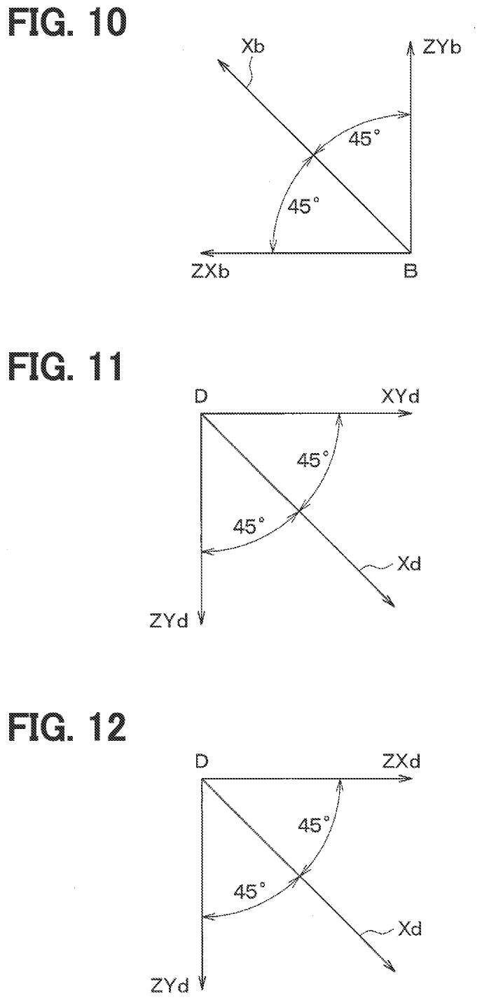

As illustrated in FIG. 10, a 45-degree angle is formed counterclockwise from ZYb to Xb between Xb and ZYb. A 45-degree angle is formed counterclockwise from Xb to ZXb between Xb and ZXb.

The plane that includes reference point D and is parallel to the X-axis and the Y-axis is hereinafter referred to as XYd. The plane that includes reference point D and is parallel to the Z-axis and the Y-axis is hereinafter referred to as ZYd.

As illustrated in FIG. 11, a 45-degree angle is formed counterclockwise from Xd to the XYd parallel plane between Xb and ZYb. A 45-degree angle is formed counterclockwise from ZYd to Xd between ZYd and Xd.

The plane that includes reference point D and is parallel to the Y-axis and the Z-axis is hereinafter referred to as ZYd. The plane that includes reference point D and is parallel to the X-axis and the Z-axis is hereinafter referred to as ZXd.

As illustrated in FIG. 12, a 45-degree angle is formed counterclockwise from ZYd to Xd between Xd and ZYd. A 45-degree angle is formed counterclockwise from Xd to ZXd between Xd and ZXd.

The plane that includes reference point C and is parallel to the X-axis and the Y-axis is hereinafter referred to as XYc. The plane that includes reference point C and is parallel to the Z-axis and the Y-axis is hereinafter referred to as ZYc.

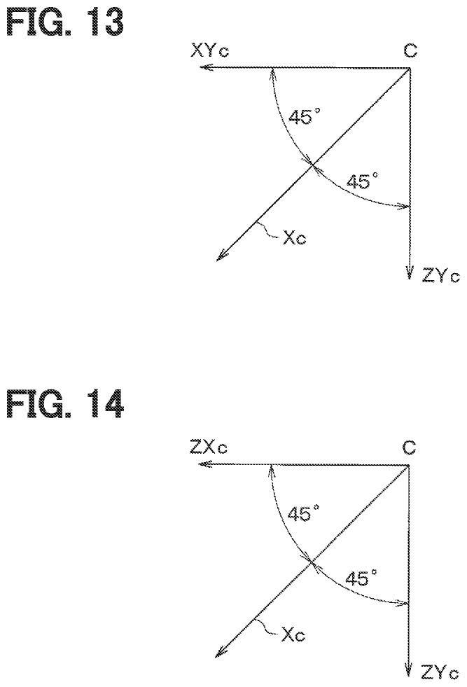

As illustrated in FIG. 13, a 45-degree angle is formed clockwise from Xc to the XYc parallel plane between Xc and XYc. A 45-degree angle is formed clockwise from ZYc to Xc between ZYc and Xc.

The plane that includes reference point C and is parallel to the Y-axis and the Z-axis is hereinafter referred to as ZYc. The plane that includes reference point C and is parallel to the X-axis and the Z-axis is hereinafter referred to as ZXc.

As illustrated in FIG. 14, a 45-degree angle is formed clockwise from ZYc to Xc between Xc and ZYc. A 45-degree angle is formed clockwise from Xc to ZXc between Xc and ZXc.

As above, the installation angles are configured for Xa, Xb, Xc, and Xd according to the present embodiment.

As illustrated in FIG. 4, concerning the elastic member 30a, the line orthogonal to Xa at reference point A is defined as Ya. Ya is the second line that extends radially around Xa. Concerning the elastic member 30b, the line orthogonal to Xb at reference point B is defined as Yb. Yb is the second line that extends radially around Xb.

Concerning the elastic member 30c, the line orthogonal to Xc at reference point C is defined as Yc. Yc is the second line that extends radially around Xc. Concerning the elastic member 30d, the line orthogonal to Xd at reference point D is defined as Yd. Yd is the second line that extends radially around Xd.

One virtual plane contains reference point A and is orthogonal to Xa. Another virtual plane contains reference point B and is orthogonal to Xb. Yet another virtual plane contains reference point C and is orthogonal to Xc. Still another virtual plane contains reference point D and is orthogonal to Xd. These four virtual planes intersect at point Q.

Virtual straight line Ya is orthogonal to Xa at reference point A and passes through point Q. Virtual straight line Yb is orthogonal to Xb at reference point B and passes through point Q. Virtual straight line Yc is orthogonal to Xc at reference point C and passes through point Q. Virtual straight line Yd is orthogonal to Xd at reference point D and passes through point Q.

The elastic member 30a, the elastic member 30b, the elastic member 30c, and the elastic member 30d maintain the same shear rigidity in the axis direction. As illustrated in 3B, the shear rigidity in the axis direction of each of the elastic members 30a, 30b, 30c, and 30d is hereinafter referred to as rigidity k1.

The elastic member 30a maintains the same shear rigidity in the radial direction orthogonal to the axis direction over the rotation direction around Xa. The elastic member 30b maintains the same shear rigidity in the radial direction orthogonal to the axis direction over the rotation direction around Xb.

The elastic member 30c maintains the same shear rigidity in the radial direction orthogonal to the axis direction over the rotation direction around Xc. The elastic member 30d maintains the same shear rigidity in the radial direction orthogonal to the axis direction over the rotation direction around Xd.

The elastic member 30a, the elastic member 30b, the elastic member 30c, and the elastic member 30dmaintain the same shear rigidity in the radial direction. As illustrated in 3B, the shear rigidity in the radial direction of each of the elastic members 30a, 30b, 30c, and 30d is hereinafter referred to as rigidity k2.

As illustrated in FIG. 4, the present embodiment configures the placement and orientation of the elastic members 30a, 30b, 30c, and 30d so that Xa, Xb, Xc, and Xd intersect at point P and Ya, Yb, Yc, and Yd intersect at point Q.

Points P, A, B, C, and D form a quadrangular pyramid (hereinafter referred to as an upper quadrangular pyramid) as a first pentahedron having each of the points as an apex. Points Q, A, B, C, and D form a quadrangular pyramid (hereinafter referred to as a lower quadrangular pyramid) as a second pentahedron having each of the points as an apex.

Each of the first and second pentahedrons is a cube composed of four triangular faces and one quadrangular face.

The position of the center of gravity G of the compressor 10 according to the present embodiment is positioned inside a virtual area as a combination of the upper quadrangular pyramid and the lower quadrangular pyramid. Specifically, line segment Sb connecting points P and Q includes the position of the center of gravity G. Suppose distance Z2 is measured along line segment Sb between point P and the position of the center of gravity G. Suppose distance Z1 is measured along line segment Sb between the position of the center of gravity G and point Q. Then, Z1/Z2 equals k1/k2.

This allows the position of the center of gravity G of the compressor 10 to correspond to elastic center Sa of the compressor 10.

The description below explains elastic center Sa of the compressor 10.

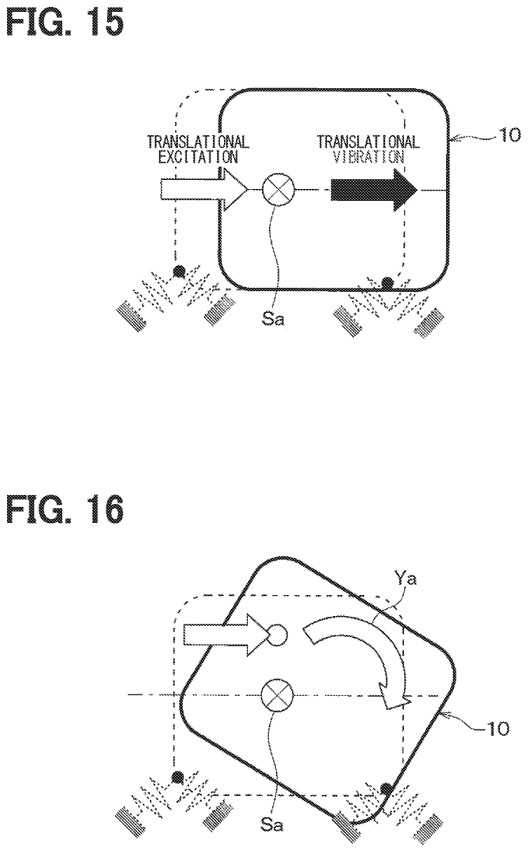

As illustrated in FIG. 15, translational vibration is applied to a specific part of the compressor 10. At this time, the compressor 10 generates translational vibration but no oscillating vibration occurs at a specific part. This specific part corresponds to elastic center Sa.

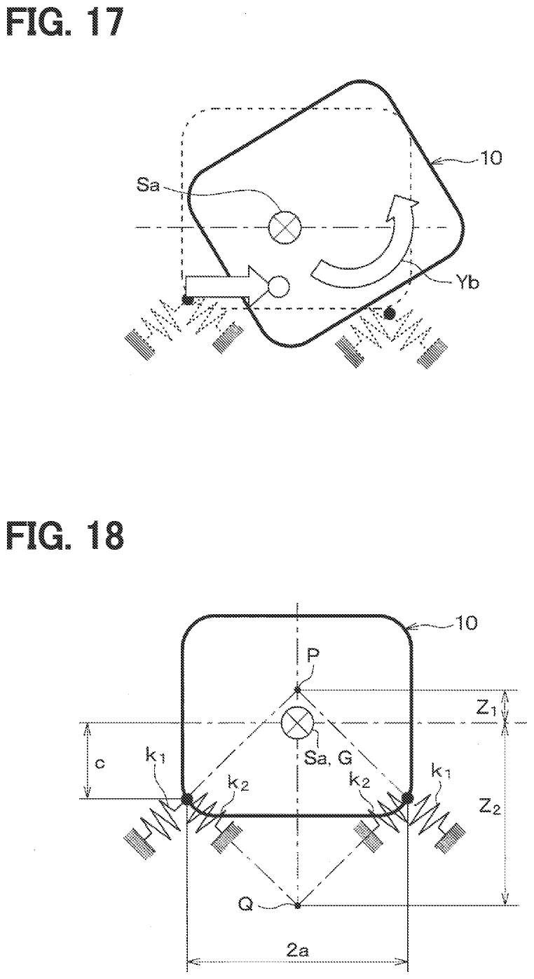

As illustrated in FIGS. 16 and 17, translational vibration is applied to parts of the compressor 10 other than the elastic center. At this time, the compressor 10 generates translational vibration and oscillating vibration.

For example, as illustrated in FIG. 16, translational vibration is applied to the compressor 10 above elastic center Sa. At this time, the compressor 10 generates translational vibration and oscillating vibration indicated by arrow Ya around elastic center Sa.

As illustrated in FIG. 17, translational vibration is applied to the compressor 10 beneath elastic center Sa. At this time, the compressor 10 generates translational vibration and oscillating vibration indicated by arrow Yb around elastic center Sa.

When translational vibration is applied to a specific part of the compressor 10, the compressor 10 may generate translational vibration but no oscillating vibration. Then, the specific part is elastic center Sa.

The position of the elastic center Sa on the compressor 10 depends on the mounting positions (a, b, c), rigidities k1 and k2 of the elastic members 30a, 30b, 30c, and 30d.

As illustrated in FIG. 18, the elastic center Sa determined as above corresponds to the position of the center of gravity G of the compressor 10. Then, it is possible to inhibit translational vibration and oscillating vibration from being coupled in six directions. Translational vibration and oscillating vibration occur independently in six directions. Then, resonance frequencies fx, fy, fz, fφ, fΨ, and fθ in six vibration modes are defined as follows.

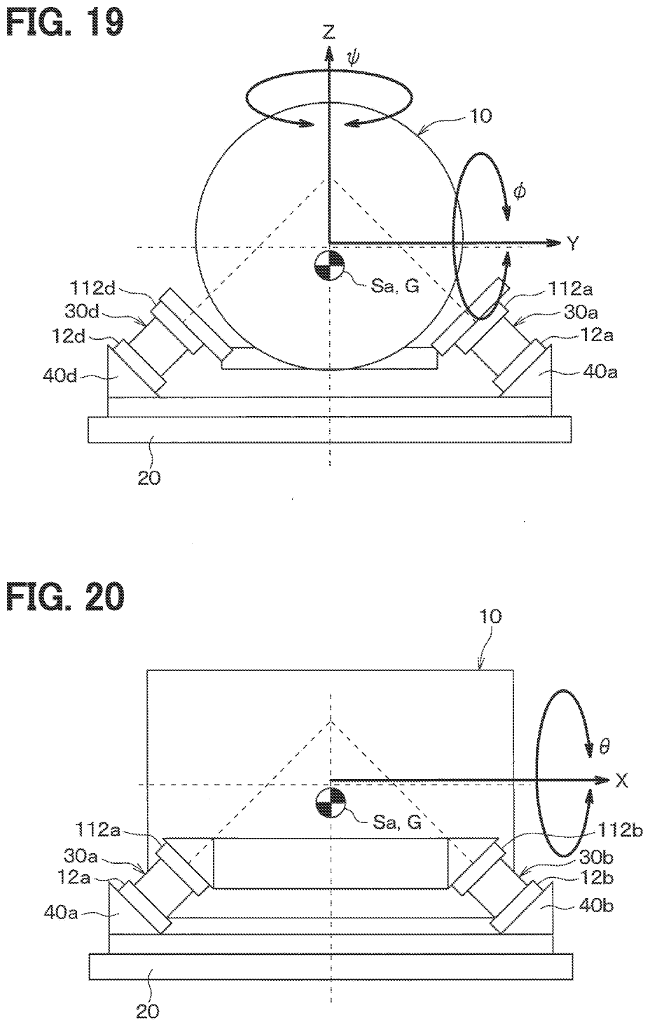

Specifically, as illustrated in FIG. 19, resonance frequency fy pertains to the translational vibration that translates along the Y-axis extending in the Y-direction from elastic center Sa (namely, the position of the center of gravity G). Resonance frequency fφ pertains to the vibration that oscillates around the Y-axis, where φ is the direction of rotation around the Y-axis.

As illustrated in FIG. 19, resonance frequency fz pertains to the vibration that translates along the Z-axis extending in the Z-direction from elastic center Sa (namely, the position of the center of gravity G). Resonance frequency fΨ pertains to the vibration that oscillates around the Z-axis, where LP is the direction of rotation around the Z-axis.

As illustrated in FIG. 20, resonance frequency fx pertains to the vibration that translates along the X-axis extending in the X-direction from elastic center Sa (namely, the position of the center of gravity G). Resonance frequency fθ pertains to the vibration that oscillates around the X-axis, where Ψ is the direction of rotation around the X-axis.

Suppose any one of the axes to be Xa out of Xa, Xb, Xc, and Xd. Then, the directional vector of Xa is assumed to be (i, j, h). Resonance frequencies fx, fy, fz, fφ, fΨ, and fθ are hereinafter represented by the directional vector (i, j, h), mounting positions (a, b, c) of the elastic members 30a, 30b, 30c, and 30d, and rigidities k1 and k2.

Equations of Math. 1 and 2 using the directional vector (i, j, h) define p and q. In the equations, m denotes the mass of the compressor 10; Ix the inertia moment of the compressor 10 in the X-direction; Iy the inertia moment of the compressor 10 in the Y-direction; and Iz the inertia moment of the compressor 10 in the Z-direction.

$$\begin{matrix}\frac{h}{j} = p & [ Math . 1 ] \\ \frac{i}{j} = q & [ Math . 2 ]\end{matrix}$$

Equations of Math. 3 and 4 express the relationship among p, q, mounting positions (a, b, c), and rigidities k1 and k2.

$$\begin{matrix}\frac{{k}_{2}}{{k}_{1}} {p}^{2} + \frac{a}{c} ( \frac{{k}_{2}}{{k}_{1}} - 1 ) pq + {p}^{2} + \frac{{k}_{2}}{{k}_{1}} = 0 & [ Math . 3 ] \\ \frac{{k}_{2}}{{k}_{1}} {p}^{2} + \frac{b}{c} ( \frac{{k}_{2}}{{k}_{1}} - 1 ) p + \frac{{k}_{2}}{{k}_{1}} {q}^{2} + 1 = 0 & [ Math . 4 ]\end{matrix}$$

The equation of Math. 5 expresses the relationship between p and q.

R=p²+q²+1 [Math. 5]

Equations of Math. 6 through 11 express resonance frequencies fx, fy, fz, fφ, fΨ, and fθ through the use of p, q, R in the equation of Math. 5, mounting positions (a, b, c), and rigidities k1 and k2.

$$\begin{matrix} {f}_{x} = \frac{1}{2 π} \sqrt{\frac{4 {k}_{1}}{mR} ( {q}^{2} + \frac{{k}_{2}}{{k}_{1}} ( {p}^{2} + 1 ) )} & [ Math . 6 ] \\ {f}_{y} = \frac{1}{2 π} \sqrt{\frac{4 {k}_{1}}{mR} ( 1 + \frac{{k}_{2}}{{k}_{1}} ( {p}^{2} + {p}^{2} ) )} & [ Math . 7 ] \\ {f}_{z} = \frac{1}{2 π} \sqrt{\frac{4 {k}_{1}}{mR} ( {p}^{2} + \frac{{k}_{2}}{{k}_{1}} ( {q}^{2} + 1 ) )} & [ Math . 8 ] \\ {f}_{θ} = \frac{1}{2 π} \sqrt{\begin{matrix}\frac{4 {k}_{1}}{{I}_{x} R} [ {c}^{2} \{ 1 + \frac{{k}_{2}}{{k}_{1}} ( {p}^{2} + {q}^{2} ) \} + {b}^{2} \{ {p}^{2} + \frac{{k}_{2}}{{k}_{1}} ( 1 + {q}^{2} ) \} - \\ 2 pbc ( 1 - \frac{{k}_{2}}{{k}_{1}} ) ]\end{matrix}} & [ Math . 9 ] \\ {f}_{ϕ} = \frac{1}{2 π} \sqrt{\begin{matrix}\frac{4 {k}_{1}}{{I}_{y} R} [ {a}^{2} \{ {p}^{2} + \frac{{k}_{2}}{{k}_{1}} ( 1 + {q}^{2} ) \} + {c}^{2} \{ {q}^{2} + \frac{{k}_{2}}{{k}_{1}} ( 1 + {p}^{2} ) \} - \\ 2 pqca ( 1 - \frac{{k}_{2}}{{k}_{1}} ) ]\end{matrix}} & [ Math . 10 ] \\ {f}_{ψ} = \frac{1}{2 π} \sqrt{\begin{matrix}\frac{4 {k}_{1}}{{I}_{z} R} [ {b}^{2} \{ {q}^{2} + \frac{{k}_{2}}{{k}_{1}} ( {p}^{2} + 1 ) \} + {a}^{2} \{ 1 + \frac{{k}_{2}}{{k}_{1}} ( {p}^{2} + {q}^{2} ) \} - \\ 2 qa ( 1 - \frac{{k}_{2}}{{k}_{1}} ) ]\end{matrix}} & [ Math . 11 ]\end{matrix}$$

The directional vector (i, h, j), the position (a, b, c), p, q, mass m of the compressor 10, inertia moments Ix, Iy, and Iz, and rigidities k1 and k2 are set to optimum values. The resonance frequencies fx, fy, fz, fφ, fΨ, and fθ then conform to each other as expressed in the equation of Math. 12.

According to the present embodiment, “conformity” not only signifies strict conformity among resonance frequencies fx, fy, fz, fφ, fΨ, and fθ, but also an aggregation of resonance frequencies fx, fy, fz, fφ, fΨ, and fθwithin a predetermined range due to manufacturing errors, for example.

fₓ=f_{y}=f_{z}=f_{θ}=f_{∅=fψ} [Math. 12]

Resonance frequencies fx, fy, fz, fφ, fΨ, and fθaccording to the present embodiment are set to achieve both the durability of the elastic members 30a, 30b, 30c, and 30d and vibration isolation capability. The vibration isolation capability is a property to inhibit the vibration generated from the compressor 10 from being transmitted to the vehicle body 20.

The present embodiment configures the installation angles of Xa, Xb, Xc, and Xd as illustrated in FIGS. 7 to 14. Therefore, the equations of Math. 13, 14, and 15 are established.

According to the present embodiment, the directional vector (i, h, j), the position (a, b, c), p, q, mass m of the compressor 10, inertia moments Ix, Iy, and Iz, rigidities k1 and k2 are set to optimum values in four equations of Math. 9, 10, 11, and 15.

$$\begin{matrix}p = q = 1 & [ Math . 13 ] \\ R = 3 & [ Math . 14 ] \\ {f}_{x} = {f}_{y} = {f}_{z} = \frac{1}{2 π} \sqrt{\frac{4 {k}_{1}}{3 m} ( 1 + 2 \frac{ {k}_{2}}{{k}_{1}} )} & [ Math . 15 ]\end{matrix}$$

According to the present embodiment configured as above, the compressor 10 operates to vibrate based on six-degree-of-freedom. The six-degree-of-freedom is a state that causes vibration to translate along the X-axis, Y-axis, and Z-axis and to oscillate around the X-axis, Y-axis, and Z-axis.

Namely, the compressor 10 causes vibrations to translate along the X-axis, vibrations to oscillate around the X-axis, vibrations to translate along the Y-axis, vibrations to oscillate around the Y-axis, vibrations to translate along the Z-axis, and vibrations to oscillate around the Z-axis.

As above, the position of the center of gravity G of the compressor 10 corresponds to elastic center Sa of the compressor 10. Therefore, this makes it possible to inhibit the coupling of translational vibration and oscillating vibration in six directions. The translational vibration and the oscillating vibration are generated independently in six directions.

The present embodiment assumes one frequency to be one predetermined frequency to achieve both the durability of the elastic members 30a, 30b, 30c, and 30d and the vibration isolation capability. Then, the resonance frequencies fx, fy, fz, fφ, fΨ, and fθ conform to the one predetermined frequency. The resonance frequencies fx, fy, fz, fφ, fΨ, and fθ correspond to the six vibration modes of the compressor 10.

According to the present embodiment described above, the vibration isolator performs vibration isolation that suppresses the vibration generated in the compressor 10 from being transmitted to the vehicle body 20. The vibration isolator includes the elastic members 30a, 30b, 30c, and 30d made of rubber as an elastic material.

The vehicle body 20 is equipped with the support portion 40 that supports the compressor 10 via the elastic members 30a, 30b, 30c, and 30d.

The elastic members 30a, 30b, 30c, and 30d are positioned between the compressor 10 and each of the leg portions 40a, 40b, 40c, and 40d of the support portion 40. The elastic members 30a, 30b, 30c, and 30d allow elastic deformation to suppress the vibration from the compressor 10 from being transmitted to the vehicle body 20 via the leg portions 40a, 40b, 40c, and 40d of the support portion 40.

As above, the position of the center of gravity G of the compressor 10 corresponds to elastic center Sa of the compressor 10. Therefore, the translational vibration and the oscillating vibration occur independently in six directions.

When the compressor 10 vibrates based on the six-degree-of-freedom, the compressor 10 and the elastic members 30a, 30b, 30c, and 30d are configured so that the resonance frequencies in the six vibration modes occurring on the compressor 10 conform to one predetermined frequency.

The directional vector (i, h, j), the position (a, b, c), p, q, mass m, inertia moments Ix, Iy, and Iz, and rigidities k1 and k2 are set to optimum values. Resonance frequencies fx, fy, fz, fφ, fΨ, and θ thereby conform to one predetermined frequency fa. The present embodiment sets predetermined frequency fa to 17 Hz.

This makes it possible to improve the vibration isolation capability in a frequency range higher than predetermined frequency fa compared to a comparative example where resonance frequencies fx, fy, fz, fφ, fΨ, and fθ differ from each other.

The present embodiment can ensure the vibration isolation capability in a frequency range higher than predetermined frequency fa while suppressing a decrease in the rigidity of the elastic members 30a, 30b, 30c, and 30d. In particular, one predetermined frequency fa is defined as one predetermined frequency to achieve both the durability of the elastic members 30a, 30b, 30c, and 30d and the vibration isolation capability.

As above, it is possible to provide a vibration isolator suited to achieve the durability of the elastic members 30a, 30b, 30c, and 30d and the vibration isolation capability of the compressor 10.

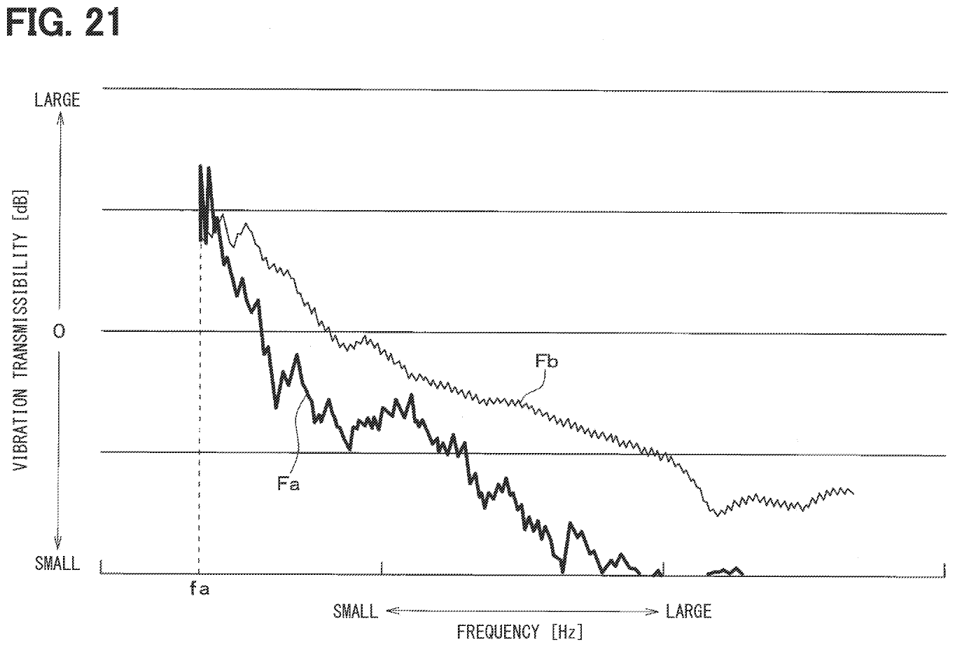

FIG. 21 illustrates a comparison between vibration transmissibility Fa of the vibration isolator according to the present embodiment and vibration transmissibility Fb of a conventional vibration isolator. FIG. 21 is a graph using the vertical axis for the vibration transmissibility and the horizontal axis for the frequency. The vibration transmissibility represents a transmission ratio of vibration transmitted from the compressor 10 to the vehicle body 20.

As illustrated in FIG. 21, the conventional vibration isolator causes different resonance frequencies in the six vibration modes. Therefore, the vibration transmissibility Fb shows a small vibration isolation effect in a frequency range higher than predetermined frequency fa.

Contrastingly, the vibration isolator according to the present embodiment allows resonance frequencies in the six vibration modes to conform to one predetermined frequency fa. Therefore, the vibration isolation effect is improved in a frequency range higher than predetermined frequency fa.

It can be seen from the above that vibration transmissibility Fa of the vibration isolator according to the present embodiment is lower in a frequency range higher than predetermined frequency fa as compared with vibration transmissibility Fb of the conventional vibration isolator.

### Second Embodiment

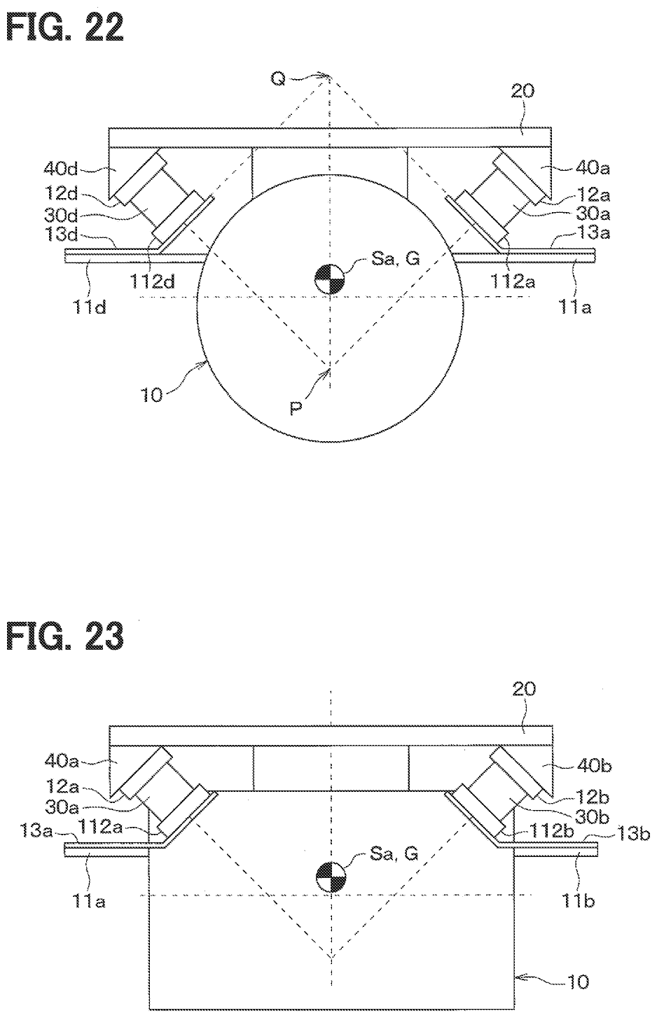

The first embodiment above has described the example of placing the compressor 10 over the vehicle body 20. Instead, the description below explains the second embodiment of placing the compressor 10 beneath the vehicle body 20 by reference to FIGS. 22 and 23.

The only difference between the present embodiment and the first embodiment is the positional relationship between the vehicle body 20 and the compressor 10. Other configurations are substantially the same.

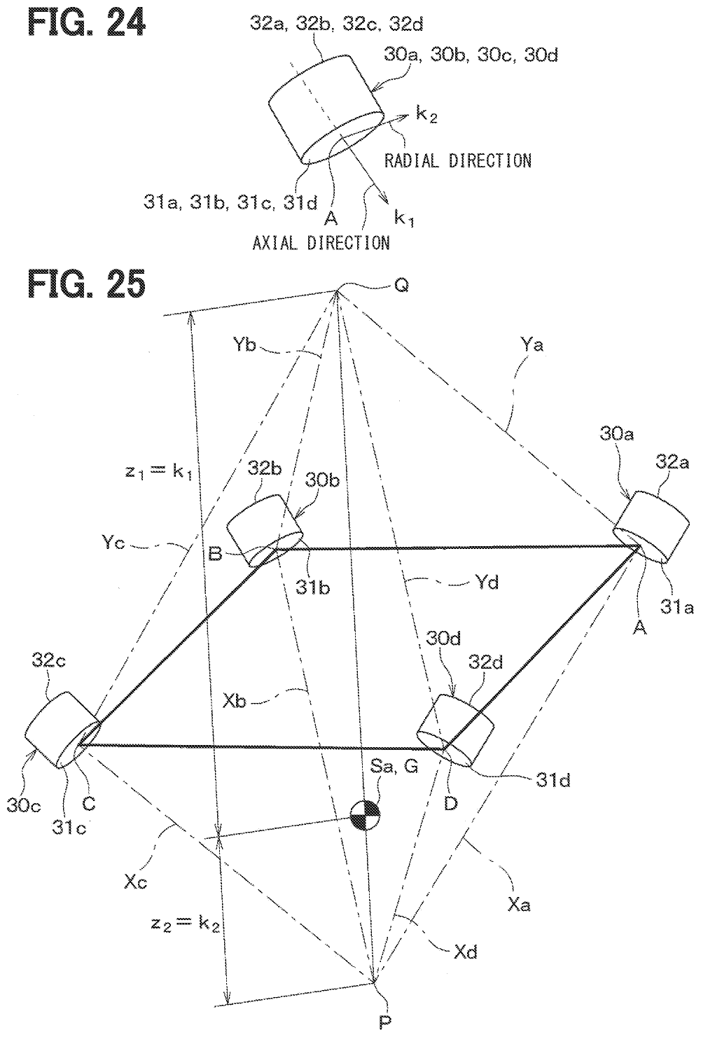

FIGS. 24 and 25 illustrate the positional relationship among the end faces 31a, 31b, 31c, and 31d, reference points A, B, C, and D, point P, and point Q of the elastic members 30a, 30b, 30c, and 30d according to the present embodiment.

According to the present embodiment, the leg portion 11a of the compressor 10 supports the elastic member 30a via a mounting member 13a. The leg portion 11b of the compressor 10 supports the elastic member 30b via a mounting member 13b.

The leg portion 11c of the compressor 10 supports the elastic member 30c via a mounting member 13c. The leg portion 11d of the compressor 10 supports the elastic member 30d via a mounting member 13d.

The mounting member 13a is fixed to the leg portion 11a of the compressor 10. The mounting member 13b is fixed to the leg portion 11b of the compressor 10. The mounting member 13c is fixed to the leg portion 11c of the compressor 10. The mounting member 13d is fixed to the leg portion 11d of the compressor 10.

The above-described vibration isolator according to the present embodiment allows the elastic members 30a, 30b, 30c, and 30d to be positioned between the compressor 10 and each of the leg portions 40a, 40b, 40c, and 40d of the support portion 40. The elastic members 30a, 30b, 30c, and 30d allow elastic deformation to suppress the vibration from the compressor 10 from being transmitted to the vehicle body 20 via the leg portions 40a, 40b, 40c, and 40d of the support portion 40.

The position of the center of gravity G of the compressor 10 corresponds to elastic center Sa of the compressor 10. The translational vibration and the oscillating vibration occur independently in six directions.

When the compressor 10 vibrates based on the six-degree-of-freedom, the compressor 10 and the elastic members 30a, 30b, 30c, and 30d are configured so that the resonance frequencies in the six vibration modes occurring on the compressor 10 conform to one predetermined frequency fa.

The directional vector (i, h, j), the position (a, b, c), p, q, mass m of the compressor 10, inertia moments Ix, Iy, and Iz, and rigidities k1 and k2 are set to optimum values. The above-described resonance frequencies in the six vibration modes thereby conform to one predetermined frequency fa.

As above, it is possible to ensure the vibration isolation capability in a frequency range higher than predetermined frequency fa while suppressing a decrease in the rigidity of the elastic members 30a, 30b, 30c, and 30d.

One predetermined frequency is defined as one predetermined frequency fa to achieve both the durability of the elastic members 30a, 30b, 30c, and 30d and the vibration isolation capability. As above, it is possible to provide a vibration isolator suited to achieve the durability of the elastic members 30a, 30b, 30c, and 30d and the vibration isolation capability of the compressor 10.

### Third Embodiment

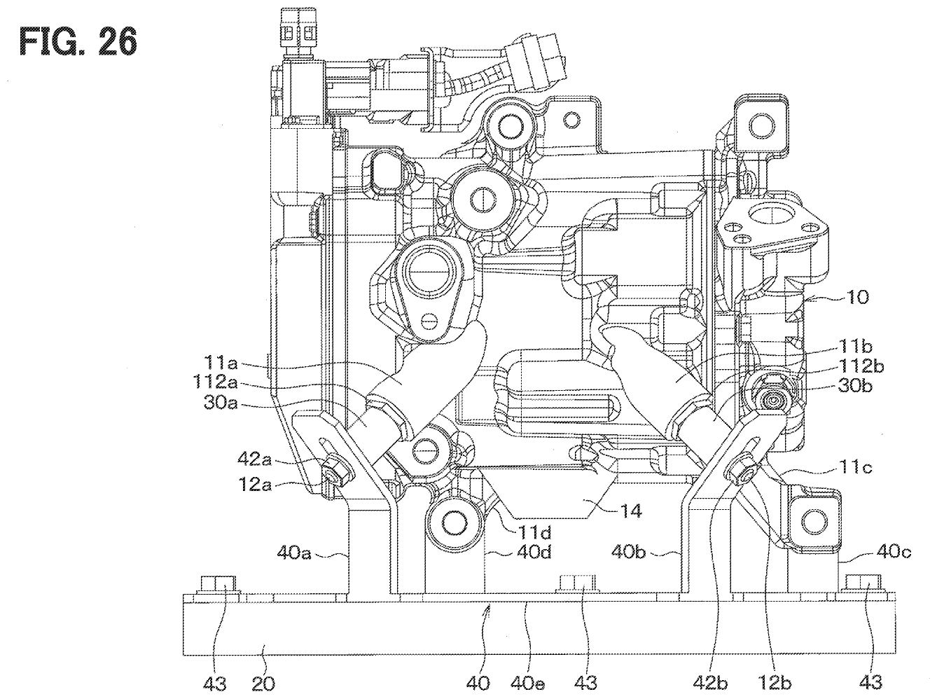

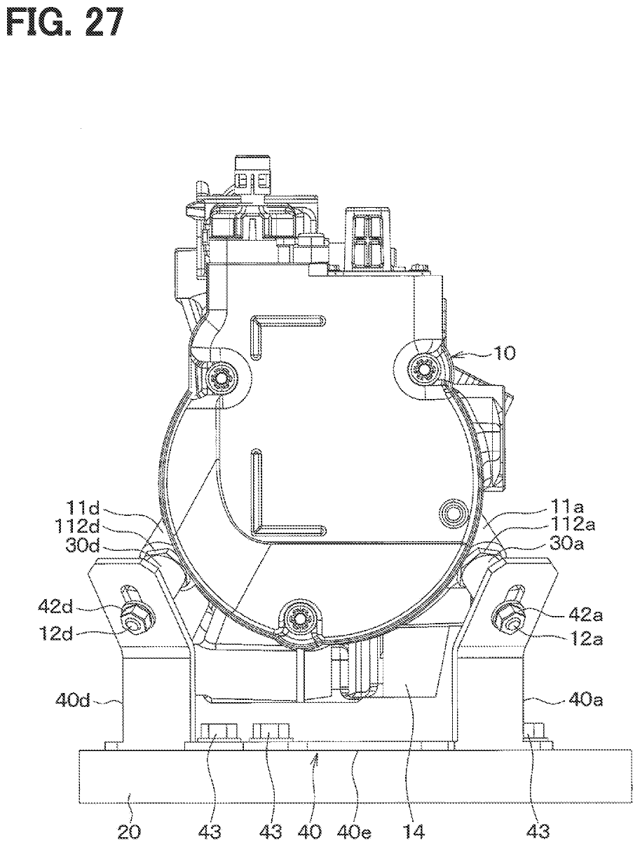

The third embodiment describes an example of providing a weight portion 14 for the compressor 10 according to the first embodiment by reference to FIGS. 26 and 27. The compressor 10 according to the present embodiment and the compressor 10 according to the first embodiment have the same configuration except for the weight portion 14. Descriptions of configurations other than the weight portion 14 will be omitted. The same reference numerals used in FIGS. 26 and 27 and in FIGS. 1 and 2 indicate the same components and the description thereof will be omitted.

The weight portion 14 is positioned beneath the compressor 10 in a vertical direction. The weight portion 14 is used to lower the position of the center of gravity G of the compressor 10 as compared with the compressor 10 according to the first embodiment.

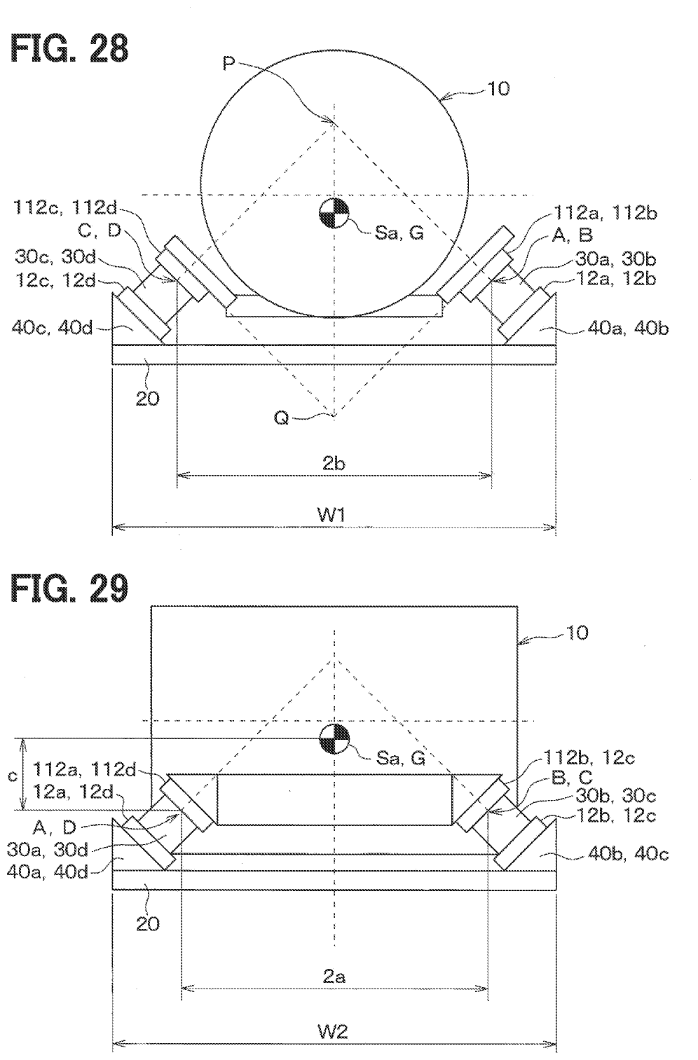

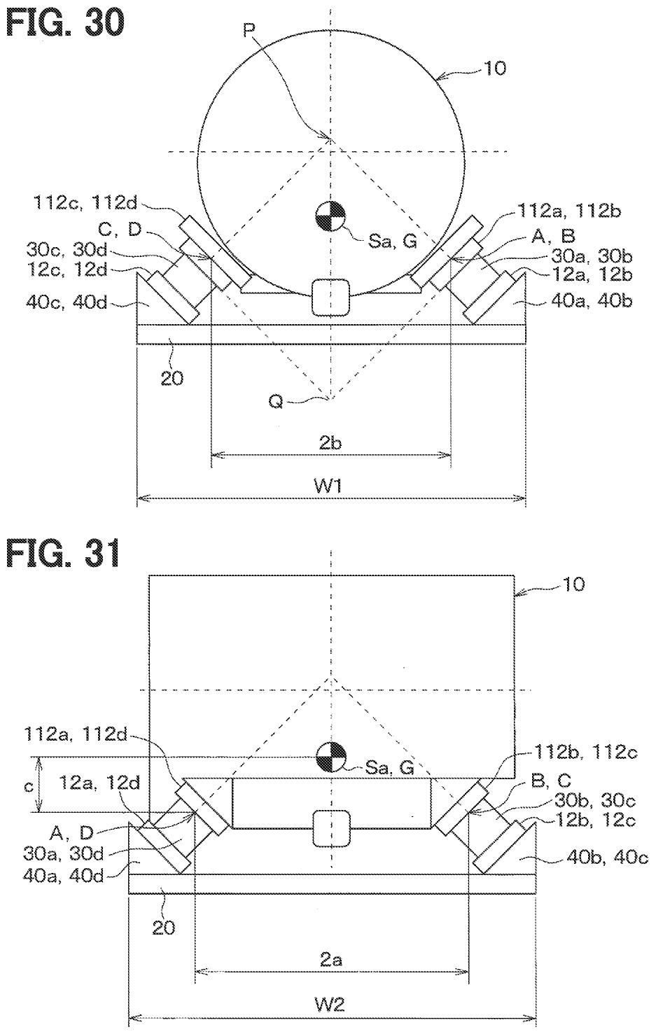

When the position of the center of gravity G of the compressor 10 is low (see FIGS. 30 and 31), the upper quadrangular pyramid and the lower quadrangular pyramid can be sized down compared to the case where the position of the center of gravity G of compressor 10 is high (see FIGS. 28 and 29). Therefore, dimensions 2a and 2b can be reduced respectively. For this reason, the weight portion 14 is positioned beneath the compressor 10 in the vertical direction. Dimensions W1 and W2 to install the compressor 10 can be reduced.

Dimension 2b denotes the distance between the elastic members 30a and 30d, or the width between the elastic members 30b and 30c. Dimension 2a denotes the distance between the elastic members 30a and 30b, or the depth between the elastic members 30d and 30c.

The above-described vibration isolator according to the present embodiment allows the position of the center of gravity G of the compressor 10 to correspond to elastic center Sa of the compressor 10. Therefore, the translational vibration and the oscillating vibration occur independently in six directions.

When the compressor 10 vibrates based on the six-degree-of-freedom, the compressor 10 and the elastic members 30a, 30b, 30c, and 30d are configured so that the resonance frequencies in the six vibration modes occurring on the compressor 10 conform to one predetermined frequency.

The directional vector (i, h, j), the position (a, b, c), p, q, mass m of the compressor 10, inertia moments Ix, Iy, and Iz, and rigidities k1 and k2 are set to optimum values. The above-described resonance frequencies in the six vibration modes thereby conform to one predetermined frequency fa.

The present embodiment can ensure the vibration isolation capability in a frequency range higher than predetermined frequency fa while suppressing a decrease in the rigidity of the elastic members 30a, 30b, 30c, and 30d.

Similar to the first embodiment, one predetermined frequency is defined as one predetermined frequency fa to achieve both the durability of the elastic members 30a, 30b, 30c, and 30d and the vibration isolation capability. It is possible to provide a vibration isolator suited to achieve the durability of the elastic members 30a, 30b, 30c, and 30d and the vibration isolation capability of the compressor 10.

### Fourth Embodiment

The first embodiment has described the example of placing each of the elastic members 30a, 30b, 30c, and 30d between each of the leg portions 11a, 11b, 11c, and 11d of the compressor 10 and each of the leg portions 40a, 40b, 40c, and 40d of the support portion 40.

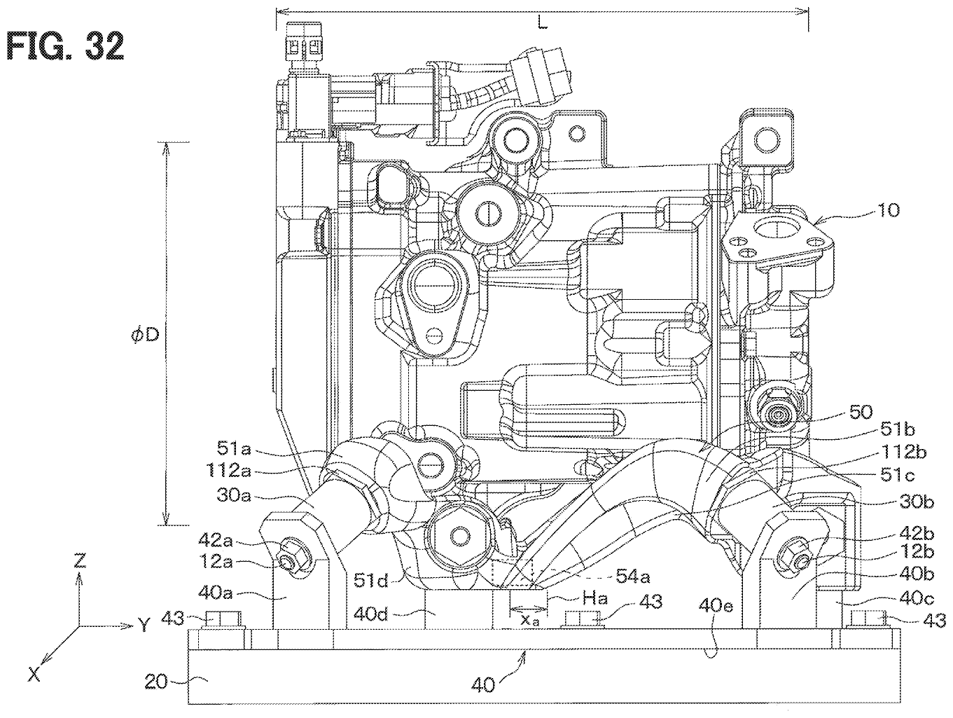

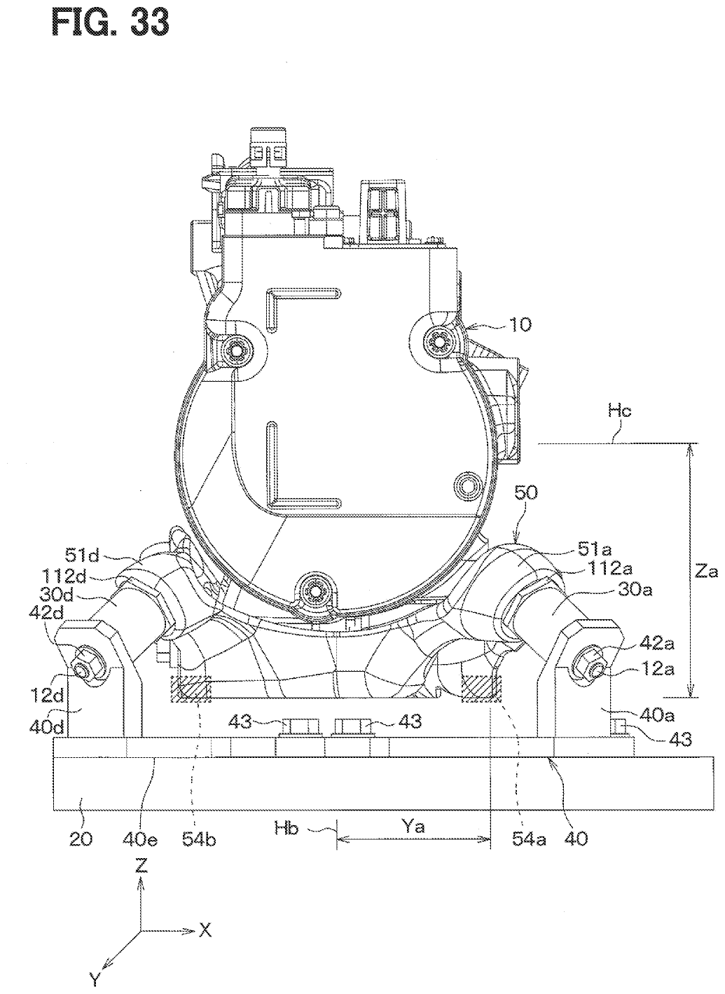

Instead, the fourth embodiment describes an example of placing one upper support portion 50 beneath the compressor 10 and placing the elastic members 30a, 30b, 30c, and 30d between the upper support portion 50 and the lower support portion 40 by reference to FIGS. 32 and 33.

The lower support portion 40 according to the present embodiment is comparable to the support portion 40 according to the first embodiment. The upper support portion 50 is comparable to a first support portion, and the lower support portion 40 is comparable to a second support portion.

The only difference between the present embodiment and the first embodiment is the upper support portion 50. Other configurations are substantially the same, and the description thereof will be omitted.

The upper support portion 50 is positioned beneath the compressor 10 in the vertical direction. The upper support portion 50 is fixed to the compressor 10 by fastening members such as bolts. The upper support portion 50 includes leg portions 51a, 51b, 51c, and 51d. The upper support portion 50 is integrated with the leg portion 51a, 51b, 51c, and 51d, inclusive.

As illustrated in FIGS. 32 and 33, the screw member 112a at one side of the elastic member 30a in the axis direction is fastened to a female screw hole of the leg portion 51a of the upper support portion 50.

The screw member 12a at the other side of the elastic member 30a in the axis direction is inserted into a through-hole of the leg portion 40a of the lower support portion 40 and is fastened with the nut 42a.

The screw member 112b at one side of the elastic member 30bin the axis direction is fastened to a female screw hole of the leg portion 51b of the upper support portion 50.

The screw member 12b at the other side of the elastic member 30b in the axis direction is inserted into a through-hole of the leg portion 40b of the lower support portion 40 and is fastened with the nut 42b.

Though not illustrated in FIGS. 32 and 33, the screw member 112c at one side of the elastic member 30c in the axis direction is fastened to a female screw hole of the leg portion 51c of the upper support portion 50.

Though not illustrated in FIGS. 32 and 33, the screw member 12c at the other side of the elastic member 30c in the axis direction is inserted into a through-hole of the leg portion 40c of the lower support portion 40 and is fastened with the nut.

The screw member 112d at one side of the elastic member 30d in the axis direction is fastened to a female screw hole of the leg portion 51d of the upper support portion 50.

The screw member 12d at the other side of the elastic member 30d in the axis direction is inserted into a through-hole of the leg portion 40d of the lower support portion 40 and is fastened with the nut 42d.

Similar to the first embodiment, the support portion 40 is fixed to the vehicle body 20.

According to the present embodiment configured as above, the elastic members 30a, 30b, 30c, and 30d allow the position of the center of gravity G to correspond to elastic center Sa of the object as an aggregate of the compressor 10 and the upper support portion 50. This is substantially similar to the first embodiment above. Consequently, the translational vibration and the oscillating vibration occur independently in six directions.

According to the present embodiment, similar to the first embodiment, the equations of Math. 6 to 11 above also express resonance frequencies fx, fy, fz, fφ, fΨ, and fθ through the use of p, q, R in the equation of Math. 5, mounting position (a, b, c), and rigidities k1 and k2.

The equations of Math. 6, Math. 7, and Math. 8 contain “m” which denotes the mass of the object as an aggregate of the compressor 10 and the upper support portion 50. The equation of Math. 9 contains “Ix” which denotes the inertia moment of the object as an aggregate of the compressor 10 and the upper support portion 50.

The equation of Math. 10 contains “Iy” which denotes the inertia moment in the Y direction of the object as an aggregate of the compressor 10 and the upper support portion 50. The equation of Math. 11 contains “Iz” which denotes the inertia moment in the Z direction of the object as an aggregate of the compressor 10 and the upper support portion 50.

The position of the center of gravity G according to the present embodiment denotes the position of the center of gravity of the object as an aggregate of the compressor 10 and the upper support portion 50. Elastic center Sa denotes elastic center Sa of the object as an aggregate of the compressor 10 and the upper support portion 50.

According to the present embodiment, the elastic members 30a, 30b, 30c, 30d, the compressor 10, and the upper support portion 50 allow resonance frequencies fx, fy, fz, fφ, fΨ, and fθ to conform to one predetermined frequency fa.

The present embodiment can ensure the vibration isolation capability in a frequency range higher than predetermined frequency fa while suppressing a decrease in the rigidity of the elastic members 30a, 30b, 30c, and 30d. Predetermined frequency fa is configured to achieve both the durability of the elastic members 30a, 30b, 30c, and 30d and the vibration isolation capability.

As above, the present embodiment can provide a vibration isolator suited to achieve the durability of the elastic members 30a, 30b, 30c, and 30d and the vibration isolation capability of the compressor 10.

### Fifth Embodiment

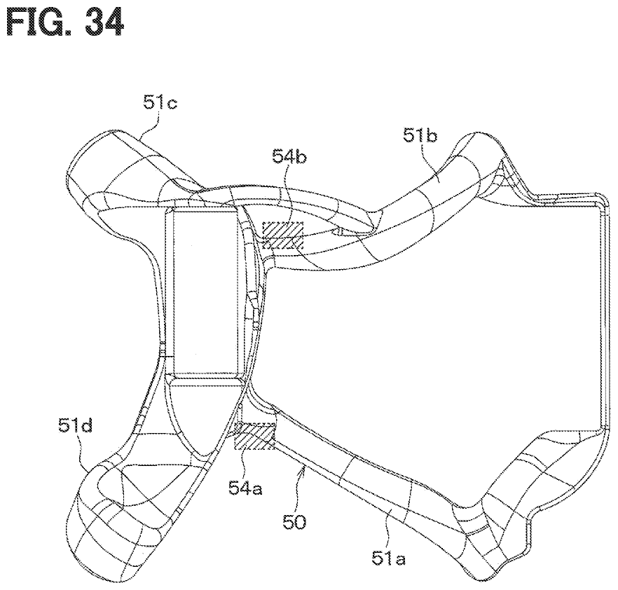

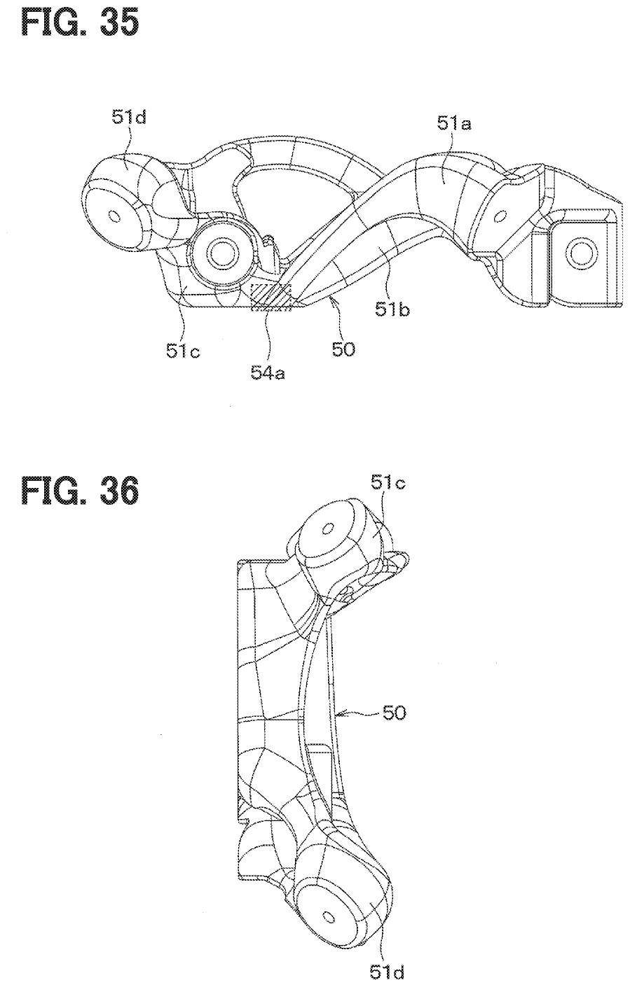

The description below explains the vibration isolator according to the fifth embodiment to provide an example of adding weight portions 54a and 54b to the upper support portion 50 according to the fourth embodiment by reference to FIGS. 34, 35, and 36.

The fifth embodiment and the fourth embodiment have the same configuration except for the weight portions 54a and 54b in the upper support portion 50. The description of the other configurations will be omitted. The weight portion 54a is positioned between the leg portions 51a and 51d of the upper support portion 50. The weight portion 54b is positioned between the leg portions 51b and 51c of the upper support portion 50.

The elastic members 30a, 30b, 30c, and 30d of the present embodiment are formed in a columnar shape. Therefore, the stiffness ratio of k2/k1 maintains the relation expressed by the equation of Math.16.

$$0 < \frac{{k}_{2}}{{k}_{1}} < 0.225 \qquad [ Math . 16 ]$$

Inertia moments Ix, Iy, and Iz of the compressor 10 need to satisfy the relation expressed by the equation of Math.17 so that resonance frequencies fx, fy, fz, fφ, fΨ, and fθ can conform to one frequency.

Iₓ=I_{y}=i×I_{z} [Math. 17]

In the equation of Math. 17, i is set to a numerical value greater than or equal to 1 and smaller than 1.3 (namely, 1≤i<1.3).

However, the axial dimension (namely, the axial length) L of the actual compressor 10 is smaller than the radial dimension φD (L<φD). Therefore, the relationship of Ix<Iy≈Iz is satisfied. It is necessary to increase Ix of the compressor 10.

Suppose mass MK is attributed to the weight portion 54a (or the weight portion 54b) positioned at the coordinates (xa, ya, za) in FIGS. 31 and 32. Then, inertia moments Ix, Iy, and Iz of the weight portion 54a (or the weight portion 54b) are expressed by the equations of Math. 18, Math. 19, and Math. 20, respectively.

Iₓ=MK(y²+z²) [Math. 18]

I_{y}=MK(x²+z²) [Math. 19]

I_{z}=MK(x²+y²) [Math. 20]

According to the present embodiment, the weight portion 54b and the weight portion 54a are positioned to be axisymmetric along virtual surface Hb as the centerline when viewed from the X-axis direction.

In the drawing, Xa denotes the distance between the weight portion 54a (or the weight portion 54b) and virtual surface Ha that is parallel to the z-axis and the y-axis including the position of the center of gravity G of the object as an aggregate of the compressor 10 and the upper support portion 50.

Ya denotes the distance between the weight portion 54a (or the weight portion 54b) and virtual surface Hb that is parallel to the z-axis and the y-axis including the position of the center of gravity G. Za denotes the distance between the weight portion 54a (or the weight portion 54b) and virtual surface Hc that is parallel to the z-axis and the y-axis including the position of the center of gravity G.

FIGS. 32 and 33 provide examples where Xa denotes the distance between virtual surface Ha and the weight portion 54a, Ya denotes the distance between virtual surface Hb and the weight portion 54a, and Za denotes the distance between virtual surface Hc and the weight portion 54a.

It can be seen that Ix can be increased by placing the weight portions 54a and 54b at positions where Xa is small and Ya and Za are large. This makes it possible to allow resonance frequencies fx, fy, fz, fφ, fΨ, and fθ to conform to one frequency.

The present embodiment configured as above provides the upper support portion 50 with weight portions 54a and 54b. Therefore, it is possible to lower the position of the center of gravity G of the object as an aggregate of the compressor 10 and the upper support portion 50 as compared with the fourth embodiment.

Namely, dimensions 2a and 2b can be reduced. Similar to the third embodiment, it is possible to decrease the dimensions to install the compressor 10.

### Sixth Embodiment

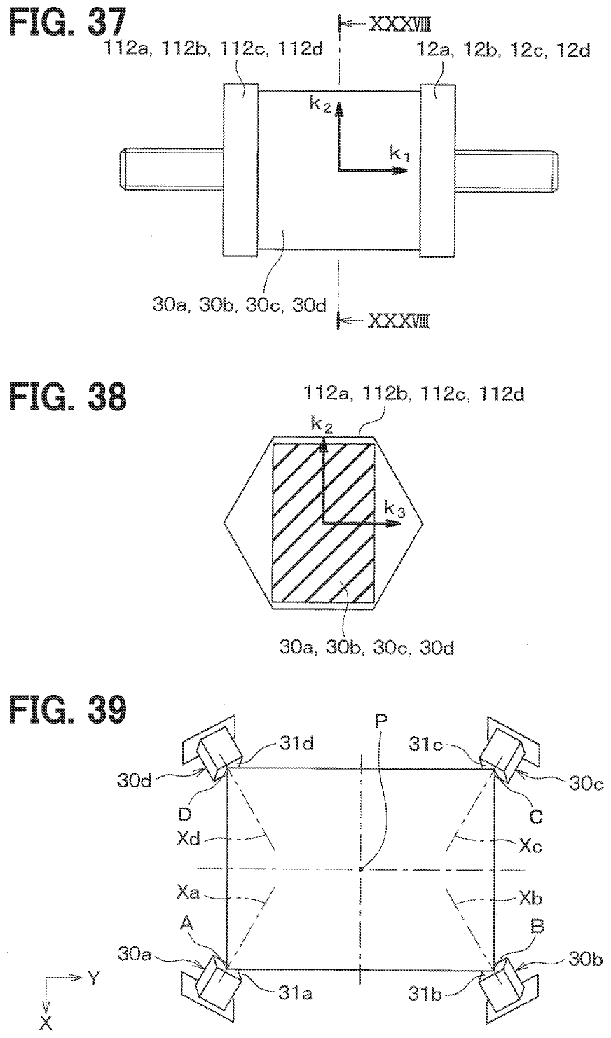

The sixth embodiment describes an example of using different rigidities k1, k2, and k3 in the three directions of the elastic members 30a, 30b, 30c, and 30d according to the first embodiment by reference to FIGS. 37 and 38, for example.

The present embodiment differs from the first embodiment only in the elastic members 30a, 30b, 30c, and 30d, and the other configurations are unchanged.

As illustrated in FIGS. 37 and 38, the elastic members 30a, 30b, 30c, and 30d are equally formed. The elastic members 30a, 30b, 30c, and 30d are prismatically formed. Specifically, the elastic members 30a, 30b, 30c, and 30d each indicate a rectangular (polygonal) cross-section orthogonal to the axis.

The elastic members 30a, 30b, 30c, and 30d each indicate the same rigidity (namely, shear rigidity) in the axis direction. The axis direction signifies a direction along which each of Xa, Xb, Xc, and Xd extends.

The elastic members 30a, 30b, 30c, and 30d each indicate the same rigidity (shear rigidity) in the first direction. The first direction is orthogonal to the axis direction and is comparable to the radial direction according to the first embodiment.

The elastic members 30a, 30b, 30c, and 30d each indicate the same rigidity (shear rigidity) in the second direction. The second direction is orthogonal to the axis direction and is orthogonal to the second direction.

The stiffness of each of the elastic members 30a, 30b, 30c, and 30d in the axis direction is assumed to be k1. The stiffness of each of the elastic members 30a, 30b, 30c, and 30d in the second direction is assumed to be k2. The stiffness of each of the elastic members 30a, 30b, 30c, and 30d in the third direction is assumed to be k3.

The directional vector (i, h, j), the position (a, b, c), p, q, mass m of the compressor 10, inertia moments Ix, Iy, and Iz, and rigidities k1 and k2 are set to optimum values. Resonance frequencies fx, fy, fz, fφ, fΨ, and fθ thereby conform to one predetermined frequency fa.

The present embodiment configures the elastic members 30a, 30b, 30c, and 30d to satisfy k1≠k2≠k3. Therefore, the six values of k1, k2, k3, p, q, and c can be used as variables despite limitations on a range of setting mass m of the compressor 10 and inertia moments Ix, Iy, and Iz.

Compared to the case of k1=k2=k3, the present embodiment can increase the degree of freedom in selecting variables to conform resonance frequencies fx, fy, fz, fφ, fΨ, and fθ Therefore, it is possible to find resonance frequencies fx, fy, fz, fφ, fΨ, fθ to further improve the durability and vibration isolation capability of the elastic members 30a, 30b, 30c, and 30d.

The description below explains resonance frequencies fx, fy, fz, fφ, fΨ, and fθ in the six vibration modes according to the present embodiment by reference to FIGS. 39, 40, and 41.

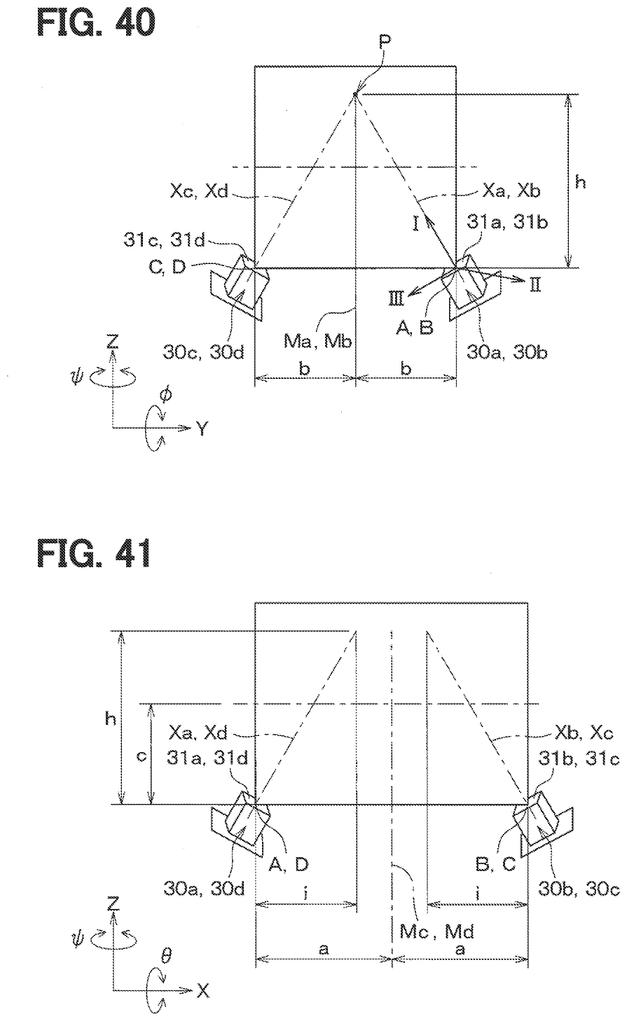

As illustrated in FIGS. 40 and 41, the present embodiment places the origin of the global coordinate axes (X, Y, Z) at the center of the elastic members 30a, 30b, 30c, 30d, and defines rotation angles (θ, φ, Ψ) around coordinate axes such as the X-axis, Y-axis, and Z-axis.

The elastic members 30a, 30b, 30c, and 30d are positioned to be axisymmetric along the global coordinate axes (X, Y, Z). Specifically, the elastic members 30a and 30c are positioned to be axisymmetric along the Z-axis as the centerline. The elastic members 30b and 30d are positioned to be axisymmetric along the Z-axis as the centerline.

The elastic members 30a and 30b are positioned to be axisymmetric along the X-axis as the centerline. The elastic members 30d and 30c are positioned to be axisymmetric along the X-axis as the centerline. The elastic members 30a and 30d are positioned to be axisymmetric along the Y-axis as the centerline. The elastic members 30b and 30c are positioned to be axisymmetric along the Y-axis as the centerline.

θ denotes a rotation angle (namely, an oscillation angle) around the X-axis. φ denotes a rotation angle (namely, an oscillation angle) around the Y-axis. Ψ denotes the rotation angle (namely, an oscillation angle) around the Z-axis.

Suppose the elastic members 30a and 30d are viewed in the X-axis direction from the positive side. As illustrated in FIG. 40, the elastic members 30a and 30d are axisymmetric along virtual line Ma as the centerline that is parallel to the Z-axis between the elastic members 30a and 30d and overlaps the position of the center of gravity G. Therefore, dimension b between elastic member 30a and virtual line Ma is equal to dimension b between the elastic member 30d and virtual line Ma.

Suppose the elastic members 30b and 30c are viewed in the X-axis direction from the negative side. As illustrated in FIG. 40, the elastic members 30b and 30c are axisymmetric along virtual line Mb as the centerline that is parallel to the Z-axis between the elastic members 30b and 30c and overlaps the position of the center of gravity G. Therefore, dimension b between elastic member 30b and virtual line Mb is equal to dimension b between the elastic member 30c and virtual line Mb.

Suppose the elastic members 30a and 30b are viewed in the Y-axis direction from the positive side. As illustrated in FIG. 41, the elastic members 30a and 30b are axisymmetric along virtual line Mc as the centerline that is parallel to the Z-axis between the elastic members 30a and 30b and overlaps the position of the center of gravity G. Therefore, dimension a between elastic member 30a and virtual line Mc is equal to dimension a between the elastic member 30b and virtual line Mc.

Suppose the elastic members 30c and 30d are viewed in the Y-axis direction from the negative side. As illustrated in FIG. 41, the elastic members 30c and 30d are axisymmetric along virtual line Md as the centerline that is parallel to the Z-axis between the elastic members 30c and 30d and overlaps the position of the center of gravity G. Therefore, dimension a between elastic member 30c and virtual line Md is equal to dimension a between the elastic member 30d and virtual line Md.

Assume the coordinates to place the elastic member 30 as (a, b, -c). Assume the coordinates to place the elastic member 30b as (-a, b, -c). Assume the coordinates to place the elastic member 30c as (-a, -b, -c). Assume the coordinates to place the elastic member 30d as (a, -b, -c).

Axis I represents an axis extending in each compression direction of the elastic members 30a, 30b, 30c, and 30d. The compression direction corresponds to the direction in which the axes Xa, Xb, Xc, and Xd of the elastic members 30a, 30b, 30c, and 30d extend.

Axis II represents an axis extending in a shearing direction orthogonal to axis I for the elastic members 30a, 30b, 30c, and 30d. Axis III represents an axis extending in the shear direction orthogonal to axis I and axis II for the elastic members 30a, 30b, 30c, and 30d (see FIG. 40).

As above, the elastic members 30a, 30b, 30c, and 30d are identically formed. The description below explains axes I, II, and II by using the elastic member 30a out of the elastic members 30a, 30b, 30c, and 30d as a representative example.

On the X-Z plane, axis I of the elastic member 30a is configured to pass through the position of the elastic member 30a and “a point causing the distance of i in the X-direction and the distance of h in the Z-direction from the position of the elastic member 30a.” On the Y-Z plane, axis I of the elastic member 30a is configured to pass through the position of the elastic member 30a and “a point causing the distance of b in the negative Y-direction and the distance of h in the Z-direction from the position of the elastic member 30a.”

Axis II of the elastic member 30a is orthogonal to axis I. Axis III of the elastic member 30a is orthogonal to axis I and axis II.

The elastic member 30a is configured so that p and q are expressed by the equations of Math. 21 and 22.

$$\begin{matrix}p = \frac{h}{b} & [ Math . 21 ] \\ q = \frac{i}{b} & [ Math . 22 ]\end{matrix}$$

The elastic member 30a is configured so that s and t are expressed by the equations of Math. 23 and 24.

s=\sqrt{p²+q²+1} [Math. 23]

t=\sqrt{q²+1} [Math. 24]

Tables 1 through 4 show unit direction vectors (Iᵤ, mᵤ, nᵤ, where u=1, 2, 3) of axes I, II, and III for the elastic members 30a, 30b, 30c, and 30d concerning the global coordinate axes (X, Y, Z).

Tables 1 through 4 show the unit direction vectors (Iᵤ, mᵤ, nᵤ, where u=1, 2, 3) in the form of a 3×3 matrix. In Tables 1 through 4, the rows show axes I, II, and III, and the columns show the X, Y, and Z coordinates for axes I, II, and III.

Iᵤ indicates the X coordinate, mᵤ indicates the Y coordinate, and nᵤ indicates the Z coordinate. For example, stiffness I₁ indicates the X coordinate of axis I, m₃ indicates the Y coordinate of axis III, and n₂ indicates the Z coordinate of axis II.

Specifically, axes I, II, and III of the elastic member 30a indicate the unit direction vectors (Iᵤ, mᵤ, nᵤ, where u=1, 2, 3) as illustrated in Table 1.

TABLE 1

| | | axis I | axis II | axis III |
|---|---|---|---|---|
| global coordinate system | x | ${I}_{1} = \frac{- q}{s}$ | ${I}_{2} = \frac{- p q}{s t}$ | ${I}_{3} = \frac{1}{t}$ |
| | y | ${m}_{1} = \frac{- 1}{s}$ | ${m}_{2} = \frac{- p}{s t}$ | ${m}_{3} = \frac{- q}{t}$ |
| | z | ${n}_{1} = \frac{p}{s}$ | ${n}_{2} = \frac{- t}{s}$ | O |

The elastic member 30b can be configured by substituting “-i” for “i” and substituting “-q” for “q” on the elastic member 30. Then, axes I, II, and III of the elastic member 30b indicate the unit direction vectors (Iᵤ, mᵤ, nᵤ, where u=1, 2, 3) as illustrated in Table 2.

TABLE 2

| | | axis I | axis II | axis III |
|---|---|---|---|---|
| global coordinate system | x | ${I}_{1} = \frac{q}{s}$ | ${I}_{2} = \frac{p q}{s t}$ | ${I}_{3} = \frac{1}{t}$ |
| | y | ${m}_{1} = \frac{- 1}{s}$ | ${m}_{2} = \frac{- p}{s t}$ | ${m}_{3} = \frac{q}{t}$ |
| | z | ${n}_{1} = \frac{p}{s}$ | ${n}_{2} = \frac{- t}{s}$ | O |

The elastic member 30c can be configured by substituting “-i” for “i,” substituting “-b” for “b,” and substituting “-p” for “p” on the elastic member 30a. Then, axes I, II, and III of the elastic member 30c indicate the unit direction vectors (lu, mu, nu, where u=1, 2, 3) as illustrated in Table 3.

TABLE 3

| | | axis I | axis II | axis III |
|---|---|---|---|---|
| global coordinate system | x | ${I}_{1} = \frac{- q}{s}$ | ${I}_{2} = \frac{p q}{s t}$ | ${I}_{3} = \frac{1}{t}$ |
| | y | ${m}_{1} = \frac{- 1}{s}$ | ${m}_{2} = \frac{p}{s t}$ | ${m}_{3} = \frac{- q}{t}$ |
| | z | ${n}_{1} = \frac{- p}{s}$ | ${n}_{2} = \frac{- t}{s}$ | O |

The elastic member 30c can be configured by substituting “-b” for “b,” substituting “-p” for “p,” and substituting “-q” for “q.” Then, axes I, II, and III of the elastic member 30d indicate the unit direction vectors (Iᵤ, mᵤ, nᵤ, where u=1, 2, 3) as illustrated in Table 4.

TABLE 4

| | | axis I | axis II | axis III |
|---|---|---|---|---|
| global coordinate system | x | ${I}_{1} = \frac{q}{s}$ | ${I}_{2} = \frac{- p q}{s t}$ | ${I}_{3} = \frac{1}{t}$ |
| | y | ${m}_{1} = \frac{- 1}{s}$ | ${m}_{2} = \frac{p}{s t}$ | ${m}_{3} = \frac{q}{t}$ |
| | z | ${n}_{1} = \frac{- p}{s}$ | ${n}_{2} = \frac{- t}{s}$ | O |

The direction in which axis I extends is defined as the first axis direction. The direction in which axis II extends is defined as the second axis direction. The direction in which axis III extends is defined as the third axis direction. Suppose a force is applied to the elastic member 30a in one direction different from the first axis direction, the second axis direction, and the third axis direction Then, the elastic member 30a is displaced in three directions, namely, the X direction, the Y direction, and the Z direction.

As illustrated in Table 5 below, the elastic member 30a is given nine shear rigidities (k₁₁, k₁₂, k₁₃, k₂₁, k₂₂, k₂₃, k₃₁, k₃₂, K₃₃) arranged in the form of a 3×3 matrix.

In Table 5, the rows denote the X, Y, and Z directions as load directions in which the force is applied to the elastic member 30a. The columns denote the X, Y, and Z directions as displacement directions in which the elastic member 30a is displaced.

TABLE 5

| | | displacement direction | | |
|---|---|---|---|---|
| | | x | y | z |
| load direction | x | k₁₁ | k₁₂ | k₁₃ |
| | y | k₂₁ | k₂₂ | k₂₃ |
| | z | k₃₁ | k₃₂ | k₃₃ |

Similar to the elastic member 30a, the elastic members 30b, 30c, and 30d are also given nine shear rigidities.

Suppose rigidity k10 denotes the shear rigidity in the first axis direction (namely, compression direction) in which axis I extends on each of the elastic members 30a, 30b, 30c, and 30d. Suppose rigidity k20 denotes the shear rigidity in the second axis direction in which axis II extends on each of the elastic members 30a, 30b, 30c, and 30d. Suppose rigidity k30 denotes the shear rigidity in the third axis direction in which axis III extends on each of the elastic members 30a, 30b, 30c, and 30d.

The shear rigidities in the first axis direction, the second axis direction, and the third axis direction are defined as k10, k20, and k30 to clarify the distinction between the notation of nine shear rigidities in Table 5 and the notation of the shear rigidities in the first axis direction, the second axis direction, and the third axis direction.

Rigidity k10 is equal to rigidity k1. Rigidity k20 is equal to rigidity k2. Rigidity k30 is equal to rigidity k3.

The present embodiment configures the elastic members 30a, 30b, 30c, and 30d so that k10 # k20 # k30 is satisfied.

The equations of Math. 25, Math. 26, Math. 27, Math. 28, Math. 29, and Math. 30 express nine rigidities (k₁₁, k₁₂, k₁₃, k₂₁, k₂₂, k₂₃, k₃₁, k₃₂, k₃₃) defined for each one of the elastic members 30a, 30b, 30c, and 30d.

k₁₁=k₁₀I₁²+k₂₀ I₂²+k₃₀I₃² [Math. 25]

k₂₂=k₁₀m₁²+k₂₀ m₂² +k₃₀ m₃²

k₃₃=k₁₀n₁²+k₂₀n₂²+k₃₀n₃² [Math. 27]

k₁₂=k₂₁=k₁₀I₁m₁+k₂₀I₂m₂+k₃₀I₃m₃ [Math. 28]

k₁₃=k₃₁=k₁₀n₁I₁+k₂₀n₂I₂+k₃₀n₃I₃ [Math. 29]

k₂₃=k₃₂=k₁₀m₁n₁+k₂₀m₂n₂+k₃₀m₃n₃ [Math. 30]

Thus, the nine rigidities defined for each elastic member are prescribed by k10, k20, k30, and the unit direction vectors (Iᵤ, mᵤ, nᵤ, where u=1, 2, 3).

The unit direction vectors (Iᵤ, mᵤ, nᵤ, where u=1, 2, 3) in Table 1 are used to find the rigidities (k₁₁, k₁₂, k₁₃, k₂₁, k₂₂, k₂₃, k₃₁, k₃₂, k₃₃) of the elastic member 30a.

The unit direction vectors (Iᵤ, mᵤ, nᵤ, where u=1, 2, 3) in Table 2 are used to find the rigidities (k₁₁, k₁₂, k₁₃, k₂₁, k₂₂, k₂₃, k₃₁, k₃₂, k₃₃) of the elastic member 30b.

The unit direction vectors (Iᵤ, mᵤ, nᵤ, where u=1, 2, 3) in Table 3 are used to find the rigidities (k₁₁, k₁₂, k₁₃, k₂₁, k₂₂, k₂₃, k₃₁, k₃₂, k₃₃) of the elastic member 30c.

The unit direction vectors (Iᵤ, mᵤ, nᵤ, where u=1, 2, 3) in Table 3 are used to find the rigidities (k₁₁, k₁₂, k₁₃, k₂₁, k₂₂, k₂₃, k₃₁, k₃₂, k₃₃) of the elastic member 30d.

Suppose a load is applied to the elastic members 30a, 30b, 30c, and 30d in a direction (hereafter referred to as a single-axis direction) in which one of the axes (I, II, and III) extends. Then, the elastic members 30a, 30b, 30c, and 30d are displaced in three directions such as the X direction, the Y direction, and the Z direction, and oscillate in the three directions.

The description below explains the vibration isolator as a combination of the elastic members 30a, 30b, 30c, and 30d, and the compressor 10.

However, the vibration isolator according to the fourth embodiment includes the upper support portion 50 in addition to the elastic members 30a, 30b, 30c, and 30d, and the compressor 10.

When a load is applied to the vibration isolator in any one of the X, Y, and ZY directions, the vibration isolator is displaced in three directions and oscillates in three directions. When a moment is applied to the vibration isolator in any one of the rotation directions θ, Ψ, and φ, the vibration isolator is also displaced in three directions and oscillates in three directions.

As shown in Table 6, the vibration isolator including the elastic members 30a, 30b, 30c, and 30d defines 36 rigidities (Rᵢⱼ, where I≠J) arranged in the form of a 6×6 matrix,

In Table 6, the rows include the X, Y, and Z directions as load directions to apply a load to the vibration isolator, and θ, Ψ, and φ as moment directions to apply a moment to the vibration isolator. The columns include the X, Y, and Z directions as displacement directions to displace the vibration isolator, and θ, Ψ, and φ as oscillation directions in which the vibration isolator oscillates.

According to the reciprocity theorem, the rigidity values are unchanged even if “load direction, moment direction” as the column and “displacement direction, oscillation direction” as the row are interchanged. Then, the equation of Math. 31 is true.

R_{i,j}=R_{i,j}(≠j) [Math. 31]

In the formula of Math. 31, i and j indicate the number of rows and columns for rigidity Rᵢⱼ in Table 6. The elastic members 30a, 30b, 30c, and 30d are equally shaped as described above.

Therefore, the elastic members 30a, 30b, 30c, and 30d each are given the same rigidity k10. The elastic members 30a, 30b, 30c, and 30d each are given the same rigidity k20. The elastic members 30a, 30b, 30c, and 30d each are given the same rigidity k30.

Besides, as above, the elastic members 30a, 30b, 30c, and 30d are axisymmetrically placed concerning the global coordinate axes (X, Y, Z). Therefore, the equation of Math. 32 below is true for the rigidities (R₂₁, R₃₁, R₄₁, R₆₁, R₃₂, R₅₂, R₆₂) in Table 6.

R₂₁=R₃₁=R₄₁=R₆₁=R₃₂=R₅₂=R₆₂=0 [Math. 32]

Besides, the equation of Math. 33 below is true for the rigidities (R₄₃, R₅₃, R₆₃, R₅₄, R₆₄, R₆₅) in Table 6.

R₄₃=R₅₃=R₆₃=R₅₄=R₆₄=R₆₅=0 [Math. 33]

The translational vibration and the oscillating vibration are decoupled to reduce the number of resonance frequencies occurring on the compressor 10. Namely, the translational vibration and the oscillating vibration occur independently on each of the X-axis, Y-axis, and Z-axis.

No oscillating vibration occurs around one axis even if a load is applied to the elastic members 30a, 30b, 30c, and 30d in the single-axis direction in which one of the axes (I, II, III) extends. Even if a moment occurs around one axis, the translational vibration is prevented from occurring in the single-axis direction.

This requires the equation of Math. 33 to be true for R₅₁ and R₁₅, and the equation of Math. 34 to be true for R₄₂ and R_{24.}

R₅₁=R₁₅=(k₁₁c−k₁₃a)=0 [Math. 34]

The equation of Math. 34 shows that R₅₁ and R₅₁ are zero. This signifies that the value of zero results from adding (k₁₁×c−k₁₃×a) of the elastic member 30a, (k₁₁×c−k₁₃×a) of the elastic member 30b, (k₁₁×c−k₁₃×a) of the elastic member 30c, and (k₁₁×c−k₁₃×a) of the elastic member 30d.

R₄₂=R₂₄=Σ(k₂₃b−k₂₂c)=0 [Math. 35]

The equation of Math. 35 shows that R₄₂ and R₂₄ are zero. This signifies that the value of zero results from adding (k₂₃×b−k₂₂×c) of the elastic member 30a, (k₂₃×b−k₂₂×c) of the elastic member 30b, (k₂₃×b−k₂₂ ×c) of the elastic member 30c, and (k₂₃×b−k₂₂×c) of the elastic member 30d.

Math. 34 to Math. 39 express rigidities R₁₁, R₂₂, R₃₃, R₄₄, R₅₅, and R₆₆ other than rigidities R₂₁, R₃₁, R₄₁, R₆₁, R₃₂, R₅₂, R₆₂, R₄₃, R₅₃, R₆₃, R₅₄, R₆₄, and R₆₅ in Table 6.

R₁₁=Σk₁₁ [Math. 36]

In the equation of Math. 36, rigidity R₁₁ represents a value resulting from adding “rigidity k₁₁ of the elastic member 30a,” “rigidity k₁₁ of the elastic member 30b,” “rigidity k₁₁ of the elastic member 30c,” and “rigidity k₁₁ of the elastic member 30d.”

R₂₂=Σk₂₂ [Math. 37]

In the equation of Math. 37, rigidity R₂₂ represents a value resulting from adding “rigidity k₂₂ of the elastic member 30a,” “rigidity k₂₂ of the elastic member 30b,” “rigidity k₂₂ of the elastic member 30c,” and “rigidity k₂₂ of the elastic member 30d.”

R₃₃=Σk₃₃ [Math. 38]

In the equation of Math. 38, rigidity R₃₃ represents a value resulting from adding “rigidity k₃₃ of the elastic member 30a,” “rigidity k₃₃ of the elastic member 30b,” “rigidity k₃₃ of the elastic member 30c,” and “rigidity k₃₃ of the elastic member 30d.”

R₄₄=Σ(k₂₂c²+k₃₃b²−2k₂₃bc) [Math. 39]

The equation of Math. 39 calculates “k₂₂×c²+k₃₃×b²−2k₂₃×b×c” for the elastic members 30a, 30b, 30c, and 30d. Rigidity R₄₄ represents a value resulting from adding values “K₂₂×c²+k₃₃×b²−2k₂₃×b×c” calculated for the elastic members.

R₅₅=Σ(k₃₃a²+k₁₁c²−2k₃₁ca) [Math. 40]

The equation of Math. 40 calculates “K₃₃×a² k₁₁×c²−2k₃₁×c×a” for the elastic members 30a, 30b, 30c, and 30d. Rigidity R₅₅ represents a value resulting from adding values “K₃₃×a²+k₁₁×c²−2k₃₁×c×a” calculated for the elastic members.

R₆₆=Σ(k₁₁b²+k₂₂a²−2k₁₂ab) [Math. 41]

The equation of Math. 41 calculates “k₁₁×b²k₂₂×a²−2k₂₂×a×b” for the elastic members 30a, 30b, 30c, and 30d. Rigidity R₆₆ represents a value resulting from adding values “k₁₁×b²+k₂₂×a²−2k₂₂×a×b” calculated for the elastic members.

Rigidities R₁₁, R₂₂, R₃₃, R₄₄, R₅₅, and R₆₆ are prescribed by n, rigidities (k₁₁, k₁₂, k₁₃, k₂₁, k₂₂, k₂₃, k₃₁, k₃₂, k₃₃), and dimensions b, c, and a (see FIGS. 40 and 41).

The equations of Math. 42 through Math. 47 express resonance frequencies fx, fy, fz, fφ, fΨ, and fθ through the use of rigidities R₁₁, R₂₂, R₃₃, R₄₄, R₅₅, and R₆₆ prescribed above.

$$\begin{matrix}{f}_{x} = \frac{1}{2 π} \sqrt{\frac{{R}_{11}}{{m}_{cmp}}} & [ Math . 42 ] \\ {f}_{y} = \frac{1}{2 π} \sqrt{\frac{{R}_{22}}{{m}_{cmp}}} & [ Math . 43 ] \\ {f}_{z} = \frac{1}{2 π} \sqrt{\frac{{R}_{33}}{{m}_{cmp}}} & [ Math . 44 ] \\ {f}_{θ} = \frac{1}{2 π} \sqrt{\frac{{R}_{44}}{{I}_{cmp \_ x}}} & [ Math . 45 ] \\ {f}_{ψ} = \frac{1}{2 π} \sqrt{\frac{{R}_{66}}{{I}_{cmp \_ z}}} & [ Math . 46 ] \\ {f}_{ϕ} = \frac{1}{2 π} \sqrt{\frac{{R}_{55}}{{I}_{cmp \_ y}}} & [ Math . 47 ]\end{matrix}$$

The equations of Math. 42 to Math. 47 each contain “m_{cmp}” that denotes the mass of the compressor 10 according to the first embodiment or the mass of the object as an aggregate of the compressor 10 and the upper support portion 50 according to the fourth embodiment. “I_{cmp_x}” denotes the inertia moment of the object as an aggregate of the compressor 10 and the upper support portion 50. “I_{cmp_y}” denotes the inertia moment of the object as an aggregate of the compressor 10 and the upper support portion 50 in the Y direction. “I_{cmp_z}” denotes the inertia moment of the object as an aggregate of the compressor 10 and the upper support portion 50 in the Z direction.

Consequently, resonance frequencies fx, fy, fz, fφ, fΨ, and fθ are allowed to conform to one predetermined frequency fa to provide optimum values for rigidities R₁₁, R₂₂, R₃₃, R₄₄, R₅₅, and R₆₆, mass m_{cmp}and inertia moments I_{cmp_x}, I_{cmp_y}, and I_{cmp_z}.

The vibration isolation capability can be improved in a frequency range higher than predetermined frequency fa compared to a comparative example where resonance frequencies fx, fy, fz, fφ, fΨ, and fθ differ from each other. The present embodiment can ensure the vibration isolation capability in a frequency range higher than predetermined frequency fa while suppressing a decrease in the rigidity of the elastic members 30a, 30b, 30c, and 30d.

According to the present embodiment as above, resonance frequencies fx, fy, fz, fφ, fΨ, and fθ depend on rigidities R₁₁, R₂₂, R₃₃, R₄₄, R₅₅, and R₆₆. Rigidities R₁₁, R₂₂, R₃₃, R₄₄, R₅₅, and R₆₆ depend on rigidities k10, k20, and k30. Therefore, rigidities k10, k20, and k30 are used as variables to specify resonance frequencies fx, fy, fz, fφ, fΨ, and fθ.

As above, k10≠k20≠k30 is true for the elastic members 30a, 30b, 30c, and 30d. Therefore, it is possible to increase the degree of freedom in selecting variables to specify resonance frequencies fx, fy, fz, fφ, fΨ, and fθ.

### Modifications of Sixth Embodiment

The sixth embodiment has explained the example of using the rectangular cross-section orthogonal to the axis so that k1≠k2≠k3 is true for the elastic members 30a, 30b, 30c, and 30d. Instead, the following modifications (a), (b), (c), and (d) may be available.

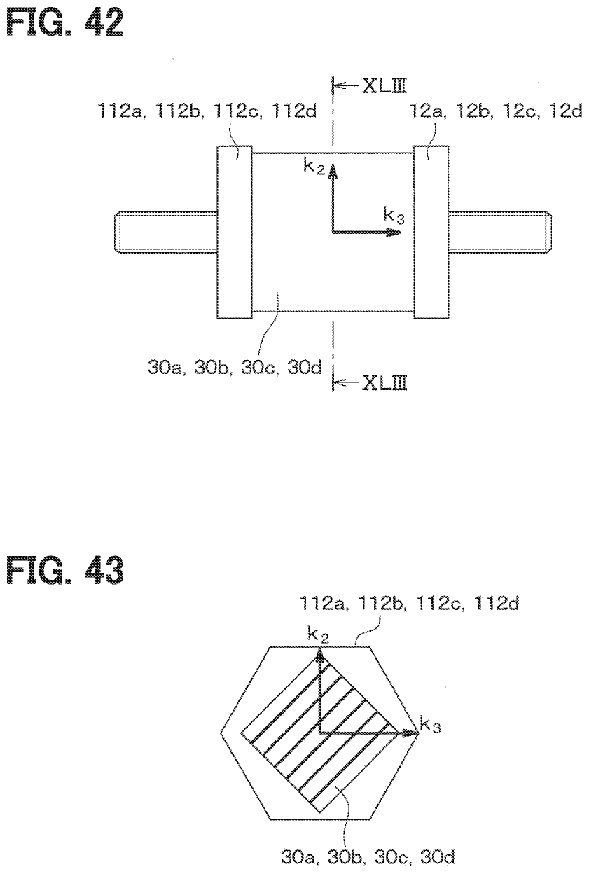

(a) As illustrated in FIGS. 42 and 43, a first modification may form a rhombic cross-section orthogonal to each axis of the elastic members 30a, 30b, 30c, and 30dso that k1≠k2≠k3 is true.

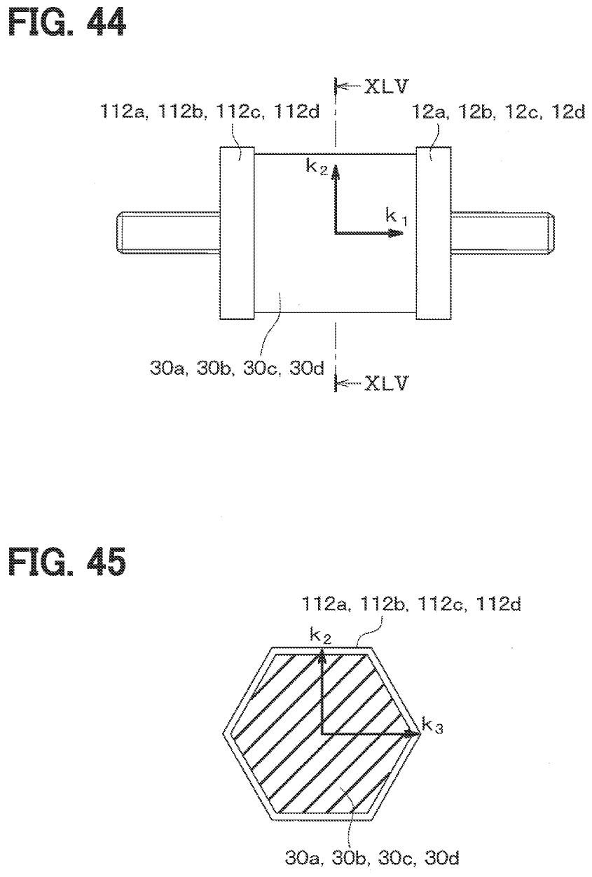

(b) As illustrated in FIGS. 44 and 45, a second modification may form a hexagonal cross-section orthogonal to each axis of the elastic members 30a, 30b, 30c, and 30d so that k1≠k2≠k3 is true.

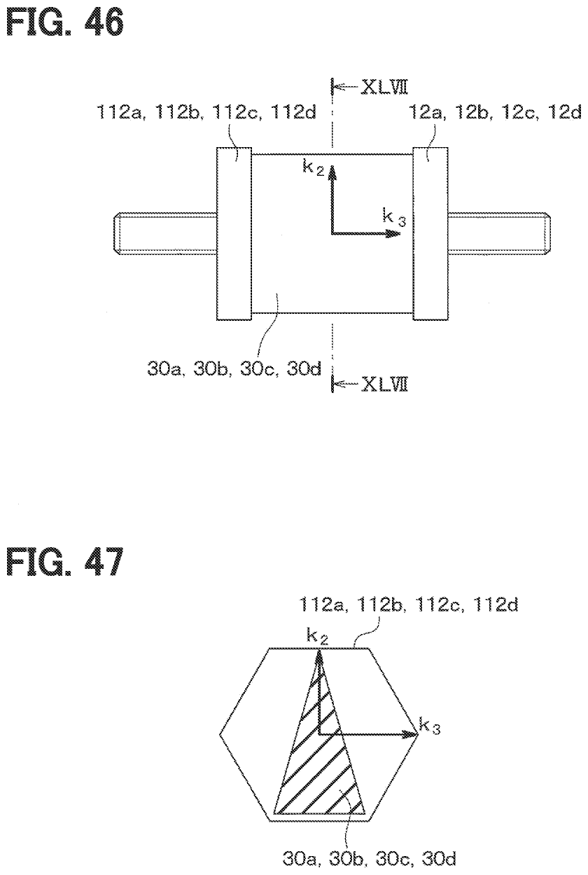

(c) As illustrated in FIGS. 46 and 47, a third modification may form a triangular cross-section orthogonal to each axis of the elastic members 30a, 30b, 30c, and 30d so that k1≠k2≠k3 is true.

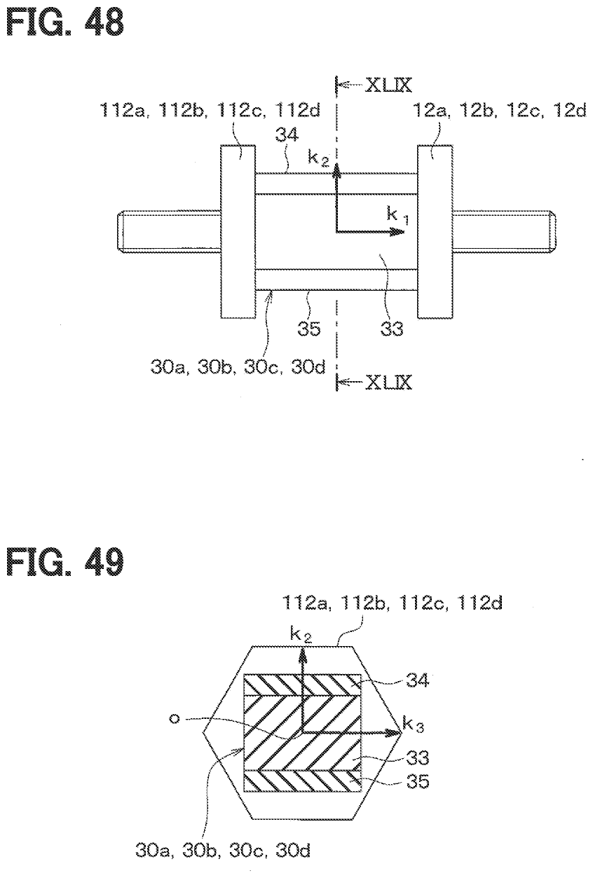

(d) As illustrated in FIGS. 48 and 49, a fourth modification forms a quadrangular cross-section orthogonal to each axis of the elastic members 30a, 30b, 30c, and 30d.

In this case, each of the elastic members 30a, 30b, 30c, and 30d includes a middle portion 33, an upper portion 34, and a lower portion 35. The middle portion 33 is formed in the shape of a long plate extending in the axis direction. The upper portion 34 is formed in the shape of a long plate extending in the axis direction along the middle portion 33. Center point o coincides with the axis in the cross-section of the middle portion 33 orthogonal to the axis direction.

The upper portion 34 is positioned on one side (namely, the upper side in FIG. 46) of the middle portion 33 in the first direction. The first direction is orthogonal to the axis direction.

The middle portion 33 and the upper portion 34 are connected. The upper portion 34 and the lower portion 35 are connected. The lower portion 35 is formed in the shape of a long plate extending in the axis direction along the middle portion 33. The lower portion 35 is positioned on the other side (namely, the lower side in FIG. 46) of the middle portion 33 in the first direction.

According to the fourth modification, the upper portion 34, the lower portion 35, and the middle portion 33 are each composed of elastic members such as rubber. Young's modulus of the upper portion 34 differs from Young's modulus of the middle portion 33. Young's modulus of the lower portion 35 differs from Young's modulus of the middle portion 33.

According to the fourth modification, k1≠k2≠k3 is true for the elastic members 30a, 30b, 30c, and 30d based on the settings of the cross-sectional areas and Young's modulus given to the upper portion 34, the lower portion 35, and the middle portion 33.

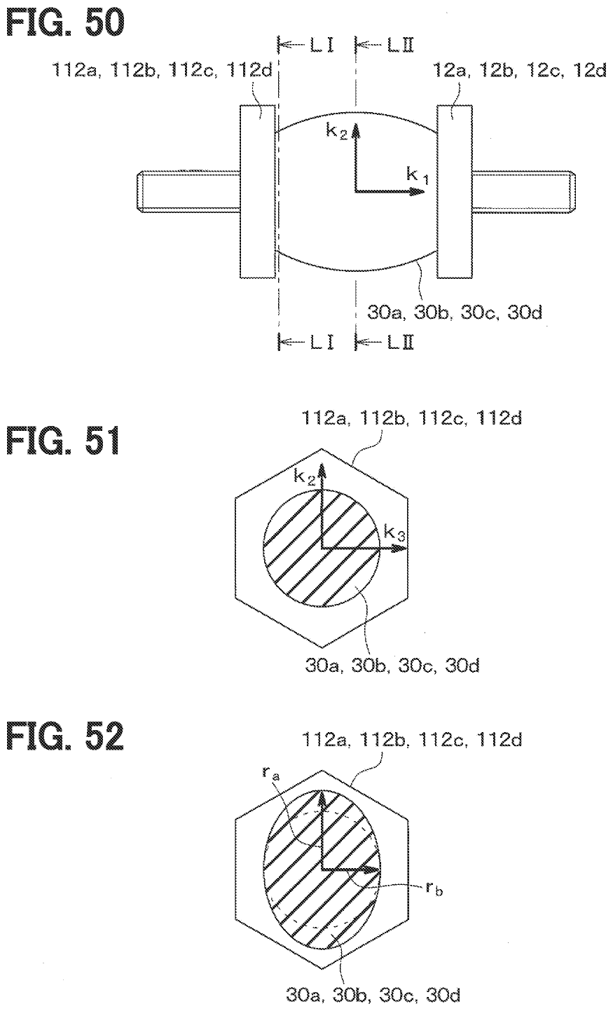

(e) As illustrated in FIGS. 50, 51, and 52, a fifth modification forms a circular cross-section orthogonal to the axis of each of the elastic members 30a, 30b, 30c, and 30d.

According to the fifth modification, the radius in the first radial direction is assumed to be radius ra, and the radius in the second radial direction is assumed to be radius rb on the cross-section orthogonal to the axis of each of the elastic members 30a, 30b, 30c, and 30d. The first radial direction is orthogonal to the axis direction. The second radial direction is orthogonal to the first radial direction and is orthogonal to the axis direction.

In this case, radius rb remains unchanged in the first radial direction over the axis direction on the cross-section orthogonal to the axis of each of the elastic members 30a, 30b, 30c, and 30d. Radius ra decreases corresponding to advancement from the center to one side in the axis direction. Radius ra decreases corresponding to advancement from the center to the other side in the axis direction.

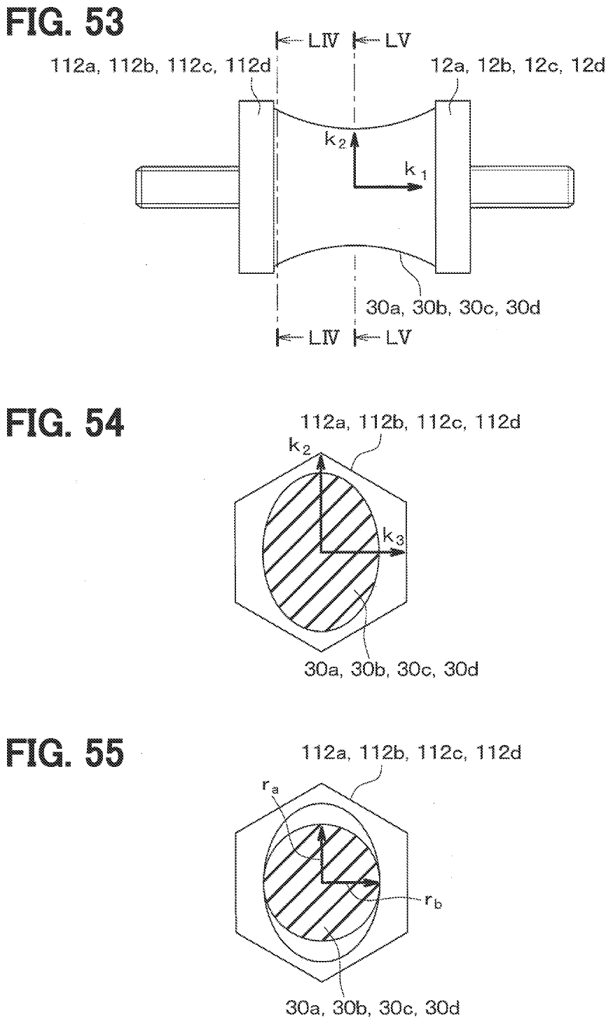

(f) Similar to the fifth modification above, a sixth modification as illustrated in FIGS. 53, 54, and 55 forms a circular cross-section orthogonal to the axis of each of the elastic members 30a, 30b, 30c, and 30d.

According to the sixth modification, radius ra increases corresponding to advancement from the center to one side in the axis direction on the cross-section orthogonal to the axis of each of the elastic members 30a, 30b, 30c, and 30d. Radius ra increases corresponding to advancement from the center to the other side in the axis direction. Radius rb remains unchanged in the first radial direction over the axis direction.

### Seventh Embodiment

According to the first and second embodiments, the resonance frequency conforms to 17 Hz to achieve the durability and the vibration isolation effect of the elastic members. In the first and second embodiments, however, the resonance frequency may be set to a predetermined frequency other than 17 Hz as described below.

When load F vibrates the compressor 10, Math. 48 expresses strain c of the elastic member. Math. 49 expresses F in Math. 48. Math. 50 expresses the resonance frequency.

$$\begin{matrix}ɛ = \frac{F}{kL} ≦ {ɛ}_{trg} & [ Math . 48 ] \\ F = \frac{mG}{n} & [ Math . 49 ] \\ {f}_{r} = \frac{1}{2 π} \sqrt{\frac{k}{m}} & [ Math . 50 ]\end{matrix}$$

ε: Strain of the elastic member

F: Force applied to the compressor

k: Rigidity of the elastic member

L: Length of the elastic member

ε_{trg}: Endurance limit of the strain

m: Mass of the compressor 10 in the first embodiment or the sum of masses of the compressor 10 and the upper support portion 50 in the second embodiment

G: Acceleration

n: The number of elastic members

In the equations, “m” denotes the mass of the compressor 10 in the first embodiment or the mass of the object as an aggregate of the compressor 10 and the upper support portion 50 in the fourth embodiment.

As expressed in Math. 48, strain c is smaller than or equal to ε_{trg} to ensure the durability of the elastic members. Math. 48 and Math. 49 make it possible to find the minimum value of rigidity k required for this case. The resulting minimum value of rigidity k and Math. 50 make it possible to find the minimum frequency fₘᵢₙ of resonance frequency fr required for this case.

Specifically fmin is set to 15 Hz under the condition of m=6.0 kg, n=4, G=40 m/sec², ε_{trg}=30%, and L=30 mm. Therefore, the resonance frequency needs to be 15 Hz or higher to ensure the durability of the elastic members.

The equation in Math. 51 is used to find vibration transmissibility H (f) at frequency f. The equation in Math. 51 is used when the resonance frequencies in the six vibration modes are aggregated into one frequency.

$$H ( f ) = \frac{\sqrt{1 + {tan}^{2} δ}}{\sqrt{{( 1 - {( \frac{f}{{f}_{r}} )}^{2} )}^{2} + {tan}^{2} δ}} \qquad [ Math . 51 ]$$

fᵣ: Resonance frequency

tan δ: Decay rate of the elastic member

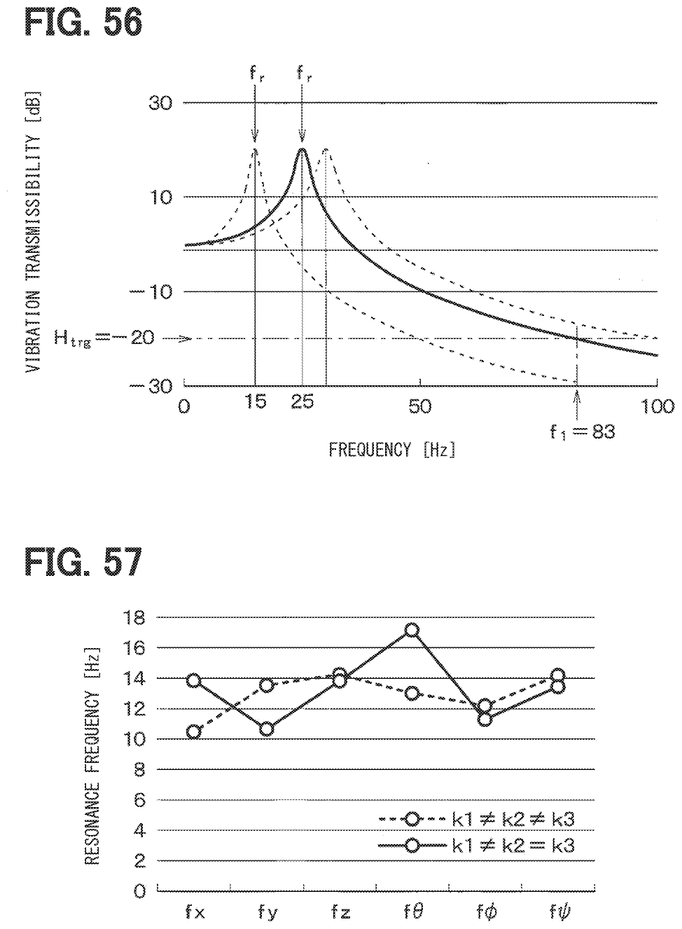

As illustrated in FIG. 56, resonance frequency fᵣ needs to be lower than or equal to fₘₐₓ so that the vibration transmissibility at the frequency f₁ higher than the resonance frequency comes to be smaller than or equal to target value H_{Trg}. In actual use, the vibration transmissibility at f₁=83 Hz is required to be smaller than or equal to H_{Trg}=−20. According to Math. 19, the required resonance frequency is lower than or equal to 25 Hz in this case.

The resonance frequencies in the six vibration modes may be set to conform to predetermined frequencies in the range of 15 Hz to 25 Hz other than 17 Hz to achieve the durability and the vibration isolation effect of the elastic members. This makes it possible to provide effects similar to those of the first and second embodiments.

The above-described embodiments aggregate the resonance frequencies in the six vibration modes into one frequency. However, the resonance frequencies in the six vibration modes need not be aggregated into one frequency. The resonance frequencies in the six vibration modes only need to be aggregated within the range of 10 Hz from 15 Hz to 25 Hz described above. Namely, it is only necessary to ensure 10 Hz or less as an absolute value of the difference between the maximum value and the minimum value of the resonance frequencies in the six vibration modes. In this case, also, it is presumed to provide effects similar to those of the first and second embodiments.

### Eighth Embodiment

The eighth embodiment describes an example of combining the seventh embodiment and the sixth embodiment by reference to FIG. 57.

Similar to the sixth embodiment, the present embodiment configures the elastic members 30a, 30b, 30c, and 30d so that k1≠k2≠k3 is true.

Further, the present embodiment configures the compressor 10 and the elastic members 30a, 30b, 30c, and 30d so that resonance frequencies fx, fy, fz, fφ, fΨ, and fθ fall within a predetermined range.

Namely, the directional vector (i, h, j), the position (a, b, c), p, q, mass m, inertia moments Ix, ly, and Iz, and rigidities k1, k2, and k3 are set to optimum values so that resonance frequencies fx, fy, fz, fφ, fΨ, and fθ fall within a specified range.

Mass m denotes the mass of the compressor 10 in the first embodiment or the mass of the object as an aggregate of the compressor 10 and the upper support portion 50 in the fourth embodiment.

Similar to the six embodiment, the present embodiment configures the elastic members 30a, 30b, 30c, and 30d so that k1≠k2≠k3 is true. Therefore, the present embodiment can increase the degree of freedom in selecting variables to aggregate resonance frequencies fx, fy, fz, fφ, fΨ, and fθ compared to the case of k1≠k2=k3.

The directional vector (i, h, j), the position (a, b, c), p, q, mass m, inertia moments Ix, Iy, and Iz, and rigidities k1, k2, and k3 are assumed to be variables.

The present embodiment can decrease the absolute value of a difference between the maximum value and the minimum value for resonance frequencies fx, fy, fz, fφ, fΨ, and fθ compared to the case where k1≠k2=k3 is true (see FIG. 57). Therefore, it is possible to further improve the durability and the vibration isolation capability of the elastic members 30a, 30b, 30c, and 30d.

FIG. 57 makes it clear that, compared to the case where k1≠k2=k3 is true, the case where k1≠k2≠k3 is true decreases the absolute value of a difference between the maximum value and the minimum value for resonance frequencies fx, fy, fz, fφ, fΨ, and fθ.

### Other Embodiments

(1) The first to eighth embodiments and the modifications have explained the examples of using the vibration source as the compressor 10. Instead, various devices other than the compressor 10 may be used as the vibration source.

(2) The first to eighth embodiments and the modifications have explained the examples of mounting the vibration source on an automobile. Instead, the vibration source may be mounted on various devices other than automobiles (including moving objects such as trains and airplanes).

In the first to eighth embodiments and the modifications, a portion to which vibration is transmitted may be assumed to be not only the vehicle body 20 of an automobile but also a seating. The seating is a device on which a vibration source is mounted.

(3) The first to eighth embodiments and the modifications have explained the examples of allowing the position of the center of gravity G to coincide with elastic center Sa. Instead, the position of the center of gravity G and elastic center Sa may be offset.

In this case, the compressor 10 conforms the resonance frequencies in multiple vibration modes where translational vibration and oscillating vibration are coupled.

(4) The first to eighth embodiments and the modifications have explained the examples of configuring the vibration isolator composed of four elastic members 30a, 30b, 30c, and 30d. Instead, the vibration isolator may be composed of one elastic member.

Instead, the vibration isolator may be composed of two or three elastic members. Further, the vibration isolator may be composed of five or more elastic members.

(5) The first to eighth embodiments and the modifications have explained the examples of vibrating the vibration source based on six-degree-of-freedom. Instead, the vibration source may be vibrated with a degree of freedom other than six-degree-of-freedom.

The degree of freedom other than six-degree-of-freedom signifies that the degree of freedom is greater than or equal to 1 and smaller than 6, or is greater than or equal to 7.

(6) The fourth embodiment has explained the example where resonance frequencies fx, fy, fz, fφ, fΨ, and fθ conform to one predetermined frequency fa.

Instead, the upper support portion 50, the compressor 10, and the elastic members 30a, 30b, 30c, and 30d may be configured to ensure 10 Hz as the absolute value of a difference between the maximum valued and the minimum values for resonance frequencies fx, fy, fz, fφ, fΨ, and fθ.

Namely, the directional vector (i, h, j), the position (a, b, c), p, q, mass m of the compressor 10, inertia moments Ix, Iy, and Iz, and rigidities k1 and k2 may be set to optimum values to ensure 10 Hz as the absolute value of a difference between the maximum value and the minimum value described above.

(7) The fourth embodiment has explained the examples of using the upper support portion 50 as an aggregate of the leg portions 51a, 51b, 51c, and 51d as the first support portion. Besides, the leg portions 51a, 51b, 51c, and 51d may be configured independently.

(8) The fifth embodiment has explained the examples where k1≠k2≠k3 is true for the elastic members 30a, 30b, 30c, and 30d. Instead, k1=k2 and k2≠k3 may be true for the elastic members 30a, 30b, 30c, and 30d. Alternatively, k1=k3 and k2≠k3 may be true for the elastic members 30a, 30b, 30c, and 30d.

(9) The present disclosure is not limited to the embodiments described above but may be appropriately modified. The above embodiments are not necessarily unrelated to each other and can be combined in any appropriate combination unless such a combination is obviously impossible. Further, in each of the embodiments, it goes without saying that components of the embodiment are not necessarily essential except for a case in which the components are particularly clearly specified as essential components, a case in which the components are clearly considered in principle as essential components, and the like. Further, in each of the embodiments, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Also, the shape, the positional relationship, and the like of the component or the like mentioned in the above embodiments are not limited to those being mentioned unless otherwise specified, limited to the specific shape, positional relationship, and the like in principle, or the like.

### (Overview)

According to a first aspect described in all or part of the first to eighth embodiments, the modifications, and the other embodiments, the vibration isolator provides vibration isolation that inhibits the vibration generated from the vibration source from being transmitted to the vibration transmitted portion.

The vibration isolator includes at least one elastic member. The vibration transmitted portion is provided with at least one support portion that supports the vibration source via at least one elastic member.

At least one elastic member is positioned between the vibration source and at least one support portion. Elastic deformation suppresses the transmission of vibrations from the vibration source to the vibration transmitted portion from at least one support portion.

The vibration source and at least one elastic member are configured so that the resonance frequencies in multiple vibration modes generated from the vibration source, when vibrated, conform to one predetermined frequency.

According to a second aspect, the position of the center of gravity of the vibration source coincides with the elastic center of the vibration source when the vibration source vibrates based on the six-degree-of-freedom. Consequently, the vibration source generates resonance frequencies in six vibration modes corresponding to the six-degree-of-freedom as resonance frequencies in multiple vibration modes.

According to a third aspect, at least one elastic member signifies four elastic members that are formed in a columnar shape and include an axis each.

When the direction in which the axis extends is assumed to be the axis direction, one side of each of the four elastic members in the axis direction forms an end face to support the vibration source.

The axis of each of the four elastic members is defined as a first line. The point where the end face and the first line intersect is defined as an intersection. The virtual line orthogonal to the first line from the intersection is defined as a second line.

The first lines of the four elastic members intersect at point P as a single point. The intersections of the four elastic members and point P are regarded as apexes to form a first virtual pentahedron.

The second lines of the four elastic members intersect at point P as a single point. The intersections of the four elastic members and point P are regarded as apexes to form a second virtual pentahedron.

The four elastic members are configured so that the center of gravity of the vibration source is positioned inside a virtual area as a combination of the first pentahedron and the second pentahedron.

According to a fourth aspect, each of the four elastic members has a same first shear rigidity in the axis direction.

Each of the four elastic members has a same second shear rigidity in the orthogonal direction. In each of the four elastic members, suppose k1 denotes the first shear rigidity and k2 denotes the second shear rigidity. Suppose k1/k2 denotes a value resulting from dividing k1 by k2.

Suppose the position of the center of gravity denotes the position of the center of gravity of the vibration source. Then, a line segment connecting points P and Q contains the position of the center of gravity. Suppose Z1 denotes the distance measured along the line segment between the position of the center of gravity and point Q.

Suppose Z2 denotes the distance measured along the line segment between the position of the center of gravity G and point P. Suppose k1/k2 denotes a value resulting from dividing Z1 by Z2.

The four elastic members and the vibration source are configured so that the correspondence between Z1/Z2 and k1/k2 allows the position of the center of gravity of the vibration source to correspond to the elastic center of the vibration source.

According to a fifth aspect, the orthogonal direction is defined as the first direction in each of the four elastic members. The direction orthogonal to the axis direction and orthogonal to the first direction is defined as the second direction in each of the four elastic members. Each of the four elastic members has a same third shear rigidity in the second direction. The four elastic members are configured so that the second shear rigidity differs from the third shear rigidity.

The second shear rigidity and the third shear rigidity are used as variables when specifying resonance frequencies in the six vibration modes corresponding to the six-degree-of-freedom. The four elastic members are configured so that the second shear rigidity differs from the third shear rigidity, making it possible to increase the degree of freedom in selecting variables.

According to a sixth aspect, the four elastic members are configured so that the first shear rigidity, the second shear rigidity, and the third shear rigidity differ from each other.

The second shear rigidity and the third shear rigidity are used as variables when specifying resonance frequencies in the six vibration modes corresponding to the six-degree-of-freedom. The four elastic members are configured so that the first shear rigidity, the second shear rigidity, and the third shear rigidity differ from each other, making it possible to increase the degree of freedom in selecting variables.

According to a seventh aspect, at least one elastic member has a polygonal cross-sectional shape orthogonal to the axis.

According to an eighth aspect, at least one elastic member signifies four elastic members. The four elastic members are positioned beneath the vibration source in the vertical direction.

The vibration source is provided with a weight portion on the lower side in the weight direction to lower the position of the center of gravity toward the lower side in the weight direction.

Consequently, it is possible to reduce the area to place the four elastic members.

According to a ninth aspect, the vibration isolator provides vibration isolation that inhibits the vibration generated from the vibration source from being transmitted to a portion to which vibration is transmitted. The vibration isolator includes at least one elastic member. The vibration transmitted portion includes at least one support portion that supports the vibration source through at least one elastic member.

At least one elastic member is positioned between the vibration source and at least one support portion. Elastic deformation suppresses the transmission of vibrations from the vibration source to the vibration transmitted portion from at least one support portion

The vibration source and at least one elastic member are configured to keep an absolute value smaller than or equal to 10 Hz when the vibration source vibrates based on six-degree-of-freedom while maintaining the correspondence between the position of the center of gravity of the vibration source and the elastic center of the vibration source.

The absolute value represents a difference between the maximum and minimum resonance frequencies in six vibration modes corresponding to the six-degree-of-freedom.

According to a tenth aspect, the vibration isolator provides vibration isolation that inhibits the vibration generated from the vibration source from being transmitted to the vibration transmitted portion.

The vibration isolator includes at least one first support portion to support the vibration source and at least one elastic member.

The vibration transmitted portion is provided with at least one second support portion to support the first support portion via at least one elastic member.

At least one elastic member is positioned between the vibration source and at least one second support portion. Elastic deformation inhibits vibration from the vibration source to the first support portion from being transmitted to the vibration transmitted portion from at least one second support portion.

The first support portion, the vibration source, and at least one elastic member are configured so that the resonance frequencies in multiple vibration modes generated from the vibration source, when vibrated, conform to one predetermined frequency.

According to an eleventh aspect, the position of the center of gravity of an object as an aggregate of the vibration source and the first support portion coincides with the elastic center of the object when the vibration source vibrates based on six-degree-of-freedom. As a result, the vibration source generates resonance frequencies in six vibration modes corresponding to the six-degree-of-freedom as resonance frequencies in multiple vibration modes.

According to a twelfth aspect, at least one elastic member signifies four elastic members. The first support portion is positioned beneath the vibration source in the vertical direction. The four elastic members are positioned on the lower side of the first support portion in the vertical direction. A weight portion to lower the position of the center of gravity in the weight direction is provided on the lower side of the first support portion in the weight direction.

Consequently, it is possible to reduce the area to place the four elastic members.

According to a thirteenth aspect, the vibration isolator provides vibration isolation that inhibits the vibration generated from the vibration source from being transmitted to the vibration transmitted portion. The vibration isolator includes at least one first support portion to support the vibration source and at least one elastic member.

The vibration transmitted portion is provided with at least one second support portion to support the first support portion via at least one elastic member.

At least one elastic member is positioned between the vibration source and at least one second support portion. Elastic deformation inhibits vibration from the vibration source to the first support portion from being transmitted to the vibration transmitted portion from at least one second support portion.

The first support portion, the vibration source, and at least one elastic member are configured to keep an absolute value smaller than or equal to 10 Hz when the vibration source vibrates based on six-degree-of-freedom while maintaining the correspondence between the position of the center of gravity of the vibration source and the elastic center of the vibration source.

The absolute value represents a difference between the maximum and minimum resonance frequencies in six vibration modes corresponding to the six-degree-of-freedom.

What is claimed is:

1. A vibration isolator configured to restrict vibration of a vibration source from being transmitted to a vibration transmitted portion, comprising:
at least one elastic member, wherein
the vibration transmitted portion is provided with at least one support portion to support the vibration source via the at least one elastic member,
the at least one elastic member is disposed between the vibration source and the at least one support portion, and is elastically deformed to suppress transmission of vibration of the vibration source to the vibration transmitted portion through the at least one support portion, and
the vibration source and the at least one elastic member are configured so that resonance frequencies in a plurality of vibration modes generated in the vibration source conform to one predetermined frequency.

2. The vibration isolator according to claim 1, wherein
when the vibration source vibrates based on six-degree-of-freedom, a position of center of gravity of the vibration source coincides with an elastic center of the vibration source, and the vibration source generates resonance frequencies in six vibration modes corresponding to the six-degree-of-freedom as resonance frequencies in the plurality of vibration modes.

3. The vibration isolator according to claim 2, wherein
the at least one elastic member signifies four elastic members, each of which is formed in a columnar shape and includes an axis,
when a direction in which the axis extends is assumed to be an axis direction, one side of each of the four elastic members in the axis direction forms an end face to support the vibration source,
the axis of each of the four elastic members is defined as a first line, a point where the end face and the first line intersect is defined as an intersection, and a virtual line extending in an orthogonal direction orthogonal to the first line from the intersection is defined as a second line,
the first lines of the four elastic members intersect at a point P as a single point to form a virtual first pentahedron whose apexes correspond to the intersections of the four elastic members and the point P,
the second lines of the four elastic members intersect at a point Q as a single point to form a virtual second pentahedron whose apexes correspond to the intersections of the four elastic members and the point Q, and
the four elastic members are configured so that the center of gravity of the vibration source is positioned inside a virtual area as a combination of the first pentahedron and the second pentahedron.

4. The vibration isolator according to claim 3, wherein
each of the four elastic members has a same first shear rigidity in the axis direction,
each of the four elastic members has a same second shear rigidity in the orthogonal direction,
each of the four elastic members uses k1 as the first shear rigidity, k2 as the second shear rigidity, and k1/k2 as a value resulting from dividing k1 by k2,
when a position of the center of gravity of the vibration source is assumed to be a position of the center of gravity, a line segment connecting the points P and Q contains the position of the center of gravity,
Z1 denotes a distance measured along the line segment between the position of the center of gravity and the point Q,
Z2 denotes a distance measured along the line segment between the position of the center of gravity and the point P,
k1/k2 denotes a value resulting from dividing Z1 by Z2, and
the four elastic members and the vibration source are configured so that a correspondence between Z1/Z2 and k1/k2 allows the position of the center of gravity of the vibration source to correspond to the elastic center of the vibration source.

5. The vibration isolator according to claim 4, wherein
each of the four elastic members assumes the orthogonal direction to be a first direction,
each of the four elastic members assumes a direction orthogonal to the axis direction and orthogonal to the first direction to be a second direction, each of the four elastic members has a same third shear rigidity in the second direction, and
the four elastic members are configured so that the second shear rigidity differs from the third shear rigidity.

6. The vibration isolator according to claim 5, wherein the four elastic members are configured so that the first shear rigidity, the second shear rigidity, and the third shear rigidity differ from each other.

7. The vibration isolator according to claim 6, wherein the at least one elastic member has a polygonal shape in a cross-section orthogonal to the axis.

8. The vibration isolator according to claim 2, wherein
the at least one elastic member signifies four elastic members,
the four elastic members are positioned beneath the vibration source in a vertical direction, and
the vibration source is provided with a weight portion on a lower side in a weight direction to lower the position of the center of gravity toward the lower side in the weight direction.

9. A vibration isolator configured to restrict vibration of a vibration source from being transmitted to a vibration transmitted portion, comprising:
at least one elastic member, wherein
the vibration transmitted portion is provided with at least one support portion to support the vibration source via the at least one elastic member,
the at least one elastic member is disposed between the vibration source and the at least one support portion, and is elastically deformed to suppress transmission of vibration of the vibration source to the vibration transmitted portion from the at least one support portion, and
when the vibration source vibrates based on six-degree-of-freedom while maintaining a correspondence between a position of center of gravity of the vibration source and an elastic center of the vibration source, the vibration source and the at least one elastic member are configured to keep an absolute value smaller than or equal to 10 Hz, the absolute value being a difference between the maximum and minimum resonance frequencies in six vibration modes corresponding to the six-degree-of-freedom.

10. A vibration isolator configured to restrict vibration of a vibration source from being transmitted to a vibration transmitted portion, comprising:
at least one first support portion to support the vibration source; and
at least one elastic member, wherein
the vibration transmitted portion is provided with at least one second support portion to support the first support portion via the at least one elastic member,
the at least one elastic member is disposed between the vibration source and the at least one second support portion, and is elastically deformed to suppress vibration of the vibration source transmitted to the first support portion from being further transmitted to the vibration transmitted portion through the at least one second support portion, and
the first support portion, the vibration source, and the at least one elastic member are configured so that resonance frequencies in a plurality of vibration modes generated in the vibration source conform to one predetermined frequency.

11. The vibration isolator according to claim 10, wherein a position of center of gravity of an object as an aggregate of the vibration source and the first support portion coincides with an elastic center of the object when the vibration source vibrates based on six-degree-of-freedom, and the vibration source generates resonance frequencies in six vibration modes corresponding to the six-degree-of-freedom as resonance frequencies in the vibration modes.

12. The vibration isolator according to claim 11, wherein
the at least one elastic member signifies four elastic members;
the first support portion is positioned beneath the vibration source in a vertical direction,
the four elastic members are positioned beneath the first support portion in a vertical direction, and
a weight portion to lower the position of center of gravity in a weight direction is provided beneath the first support portion in a weight direction.

13. A vibration isolator configured to restrict vibration of a vibration source from being transmitted to a vibration transmitted portion, comprising:
at least one first support portion to support the vibration source; and
at least one elastic member, wherein
the vibration transmitted portion is provided with at least one second support portion to support the first support portion via the at least one elastic member,
the at least one elastic member is disposed between the vibration source and the at least one second support portion, and is elastically deformed to suppress vibration of the vibration source transmitted to the first support portion from being further transmitted to the vibration transmitted portion through the at least one second support portion, and
when the vibration source vibrates based on six-degree-of-freedom while maintaining a correspondence between a position of center of gravity of the vibration source and an elastic center of the vibration source, the first support portion, the vibration source, and the at least one elastic member are configured to keep an absolute value smaller than or equal to 10 Hz, the absolute value being a difference between the maximum and minimum resonance frequencies in six vibration modes corresponding to the six-degree-of-freedom.
